(19) United States
(12) Patent Application Publication
(10) Pub. No.: US 2016/0269411 A1
(43) Pub. Date: Sep. 15, 2016

(54) System and Method for Anonymous Biometric Access Control

(71) Applicant: Ronen MALACHI, Rishon LeZion (IL)

(72) Inventor: Ronen MALACHI, Rishon LeZion (IL)

(21) Appl. No.: 15/047,662

(22) Filed: Feb. 19, 2016

(30) Foreign Application Priority Data
Mar. 12, 2015 (IL) 237700

(51) Int. Cl. H04L 29/06

(52) U.S. Cl. CPC H04L 63/10; H04L 63/0421; H04L 63/0861

(57) ABSTRACT

A database stored in a server includes records of biometric templates associated with non-personally identifiable information about of individuals, used for enrollment and verification phases of an access system. During an enrollment phase, a biometric sample and a non-personally identifying information for each are captured, and sent to be stored in the server. During verification phase, a biometric sensor captures the requesting individual biometric template and sends it to the server, that compares the requesting individual biometric template to a formerly captured stored biometric template. Upon detecting a match, the identity is considered verified, and the associated non-personally identifiable information of the record is made available for access control. The biometric sensor may capture fingerprint, hand geometry, retinal or iris scan, signature, facial features, voice print, signature, finger or eye-vein, or DNA. The non-personally identifiable information may include age, gender, residence, religion, weight, or height.

### TECHNICAL FIELD

This disclosure generally relates to an apparatus and method for creating, updating, or using an anonymous database including biometrics data, and in particular to verifying, authenticating, or access control using the anonymous database.

### BACKGROUND

Unless otherwise indicated herein, the materials described in this section are not prior art to the claims in this application and are not admitted to be prior art by inclusion in this section.

FIG. 1 shows a block diagram that illustrates a system 10 including a computer system 11 and the associated Internet 22 connection. Such configuration is typically used for computers (hosts) connected to the Internet 22 and executing a server or a client (or a combination) software. The system 11 may be used as a portable electronic device such as a notebook/laptop computer, a media player (e.g., MP3 based or video player), a desktop computer, a laptop computer, a cellular phone, a Personal Digital Assistant (PDA), an image processing device (e.g., a digital camera or video recorder), any other handheld or fixed location computing devices, or a combination of any of these devices. Note that while FIG. 1 illustrates various components of a computer system, it is not intended to represent any particular architecture or manner of interconnecting the components; as such details are not germane. It is also appreciated that network computers, handheld computers, cell phones and other data processing systems that have fewer components or perhaps more components may also be used. For example, the computer system 10 of FIG. 1 may be an Apple Macintosh computer or a Power Book, or an IBM compatible PC. The computer system 11 includes a bus 13, an interconnect or other communication mechanism for communicating information, and a processor 127, commonly in the form of an integrated circuit, coupled to the bus 13 for processing information and for executing the computer executable instructions. The computer system 11 further includes a main memory 125a, such as a Random Access Memory (RAM) or other dynamic storage device, coupled to bus 13 for storing information and instructions to be executed by processor 127. Main memory 125a also may be used for storing temporary variables or other intermediate information during execution of instructions to be executed by processor 127. The computer system 11 further includes a Read Only Memory (ROM) 125b (or other non-volatile memory) or other static storage device coupled to the bus 13 for storing static information and instructions for the processor 127. A storage device 125c, that may be a magnetic disk or optical disk, such as a hard disk drive (HDD) for reading from and writing to a hard disk, a magnetic disk drive for reading from and writing to a magnetic disk, and/or an optical disk drive (such as DVD) for reading from and writing to a removable optical disk, is coupled to bus 13 for storing information and instructions. The hard disk drive, magnetic disk drive, and optical disk drive may be connected to the system bus by a hard disk drive interface, a magnetic disk drive interface, and an optical disk drive interface, respectively. The drives and their associated computer-readable media provide non-volatile storage of computer readable instructions, data structures, program modules and other data for the general-purpose computing devices. Typically, the computer system 11 includes an Operating System (OS) stored in non-volatile storage for managing the computer resources and provides the applications and programs with access to the computer resources and interfaces. An operating system commonly processes system data and user input, and responds by allocating and managing tasks and internal system resources, such as controlling and allocating memory, prioritizing system requests, controlling input and output devices, facilitating networking, and managing files. Non-limiting examples of operating systems are Microsoft Windows, Mac OS X, and Linux.

The computer system 11 may be coupled via a bus 13 to a display 17, such as a Cathode Ray Tube (CRT), a Liquid Crystal Display (LCD), a flat screen monitor, a touch screen monitor or similar means for displaying text and graphical data to a user. The display may be connected via a video adapter for supporting the display. The display allows a user to view, enter, or edit information that is relevant to the operation of the system. An input device 18, including alphanumeric and other keys, is coupled to the bus 13 for communicating information and command selections to the processor 127. Another type of user input device is a cursor control 19, such as a mouse, a trackball, or cursor direction keys, for communicating direction information and command selections to the processor 127 and for controlling cursor movement on the display 17. This input device typically has two degrees of freedom in two axes, a first axis (e.g., x) and a second axis (e.g., y), that allows the device to specify positions in a plane.

The computer system 11 may be used for implementing the methods and techniques described herein. According to one example, those methods and techniques are performed by the computer system 11 in response to the processor 127 executing one or more sequences of one or more instructions contained in a main memory 125a. Such instructions may be read into the main memory 125a from another computer-readable medium, such as a storage device 125c. Execution of the sequences of instructions contained in the main memory 125a causes the processor 127 to perform the process steps described herein. In alternative embodiments, hard-wired circuitry may be used in place of or in combination with software instructions to implement the arrangement. Thus, embodiments of the invention are not limited to any specific combination of hardware circuitry and software.

The term “processor” is used herein to include, but not limited to, any integrated circuit or any other electronic device (or collection of electronic devices) capable of performing an operation on at least one instruction, including, without limitation, a microprocessor (μP), a microcontroller (μC), a Digital Signal Processor (DSP), or any combination thereof. A processor, such as the processor 127, may further be a Reduced Instruction Set Core (RISC) processor, Complex Instruction Set Computing (CISC) microprocessor, Microcontroller Unit (MCU), or CISC-based Central Processing Unit (CPU). The hardware of the processor 127 may be integrated onto a single substrate (e.g., silicon “die”), or distributed among two or more substrates. Furthermore, various functional aspects of a processor may be implemented solely as a software (or firmware) associated with the processor.

The terms “memory” and “storage” are used interchangeably herein and refer to any physical component that can retain or store information (that can be later retrieved) such as digital data on a temporary or permanent basis, typically for use in a computer or other digital electronic device. A memory can store computer programs or any other sequence of computer readable instructions, or data, such as files, text, numbers, audio and video, as well as any other form of information represented as a string or structure of bits or bytes. The physical means of storing information may be electrostatic, ferroelectric, magnetic, acoustic, optical, chemical, electronic, electrical, or mechanical. A memory may be in a form of an Integrated Circuit (IC, a.k.a. chip or microchip). Alternatively or in addition, a memory may be in the form of a packaged functional assembly of electronic components (module). Such module may be based on a Printed Circuit Board (PCB), such as PC Card according to Personal Computer Memory Card International Association (PCMCIA) PCMCIA 2.0 standard, or a Single In-line Memory Module (SIMM) or a Dual In-line Memory Module (DIMM), standardized under the JEDEC TESD-21C standard. Further, a memory may be in the form of a separately rigidly enclosed box such as an external Hard-Disk Drive (HDD). The capacity of a memory is commonly featured in bytes (B), where the prefix ‘K’ is used to denote kilo=2¹⁰=1024¹=1024, the prefix ‘M’ is used to denote mega=2²⁰ 1024²=1,048,576, the prefix ‘G’ is used to denote Giga=2³°=1024³=1,073,741,824, and the prefix ‘T’ is used to denote terms=2⁴⁰=1024⁴=1,099,511,627,776.

Various forms of computer-readable media may be involved in carrying one or more sequences of one or more instructions to the processor 127 for execution. For example, the instructions may initially be carried on a magnetic disk of a remote computer. The remote computer can load the instructions into its dynamic memory and send the instructions over a telephone line using a modem. A modem may be local to the computer system 11 can receive the data on the telephone line and use an infrared transmitter to convert the data to an infrared signal. An infrared detector can receive the data carried in the infrared signal, and appropriate circuitry can place the data on the bus 13. The bus 13 carries the data to the main memory 125a, from which the processor 127 retrieves and executes the instructions. The instructions received by the main memory 125a may optionally be stored on the storage device 125c either before or after execution by the processor 127.

The computer system 11 commonly includes a communication interface 129 coupled to the bus 13. The communication interface 129 provides a two-way data communication coupling to a network link 128 that is connected to a local network 24. For example, the communication interface 129 may be an Integrated Services Digital Network (ISDN) card or a modem to provide a data communication connection to a corresponding type of the telephone line. As another non-limiting example, the communication interface 129 may be a local area network (LAN) card to provide a data communication connection to a compatible LAN. For example, Ethernet based connection based on IEEE802.3 standard may be used, such as 10/100BaseT, 1000BaseT (Gigabit Ethernet), 10 Gigabit Ethernet (10GE or 10 GbE or 10 GigE per IEEE Std. 802.3ae-2002 as standard), 40 Gigabit Ethernet (40 GbE), or 100 Gigabit Ethernet (100 GbE as per Ethernet standard IEEE P802.3ba). These technologies are described in Cisco Systems, Inc. Publication number 1-587005-001-3 (6/99), “Internetworking Technologies Handbook”, Chapter 7: “Ethernet Technologies”, pages 7-1 to 7-38. In such a case, the communication interface 129 typically includes a LAN transceiver or a modem, such as Standard Microsystems Corporation (SMSC) LAN91C111 10/100 Ethernet transceiver, described in a Standard Microsystems Corporation (SMSC) data-sheet “LAN91C111 10/100 Non PCI Ethernet Single Chip MAC+PHY” Data-Sheet, Rev. 15 (Feb. 20, 2004).

An Internet Service Provider (ISP) 26 is an organization that provides services for accessing, using, or participating in the Internet 22. Internet Service Providers may be organized in various forms, such as commercial, community-owned, non-profit, or otherwise privately owned. Internet services, typically provided by ISPs, include Internet access, Internet transit, domain name registration, web hosting, and colocation. Various ISP Structures are described in the Chapter 2: “Structural Overview of ISP Networks” of the book entitled: “Guide to Reliable Internet Services and Applications”, by Robert D. Doverspike, K. K. Ramakrishnan, and Chris Chase, published 2010 (ISBN: 978-1-84882-827-8).

An arrangement 20 of a computer system connected to the Internet 22 is shown in FIG. 2. A computer system or workstation 27 is shown, including a main unit box 28, which encloses the motherboard on which the processor 127 and the memories typically mounted. The workstation 27 includes a keyboard 212 (corresponding to the input device 18), a printer 211, a computer mouse (corresponding to the cursor control 19), and a display 29, corresponding to the display 17. FIG. 2 illustrates various devices connected via the Internet 22, such as client device #1 21a, client device #2 21b, data server #1 23a, data server #2 23b, and the workstation 27, connected to the Internet 22 via the router or gateway 25 and the ISP 26.

Internet.

The Internet is a global system of interconnected computer networks that typically use the standardized Internet Protocol Suite (TCP/IP), including Transmission Control Protocol (TCP) and the Internet Protocol (IP), to serve billions of users worldwide. It is a network of networks that consists of millions of private, public, academic, business, and government networks, of local to global scope, that are linked by a broad array of electronic and optical networking technologies. The Internet carries a vast range of information resources and services, such as the interlinked hypertext documents on the World Wide Web (WWW) and the infrastructure to support electronic mail. The Internet backbone refers to the principal data routes between large, strategically interconnected networks and core routers forming the Internet. These data routes are hosted by commercial, government, academic, and other high-capacity network centers, the Internet exchange points and network access points that interchange Internet traffic between the countries, continents and across the oceans of the world. Traffic interchange between Internet service providers (often Tier 1 networks) participating in the Internet backbone exchange traffic by privately negotiated interconnection agreements, primarily governed by the principle of settlement-free peering.

The Transmission Control Protocol (TCP) is one of the core protocols of the Internet protocol suite (IP) described in RFC 675 and RFC 793, and the entire suite is often referred to as TCP/IP. TCP provides reliable, ordered and error-checked delivery of a stream of octets between programs running on computers connected to a local area network, intranet or the public Internet. It resides at the transport layer. Web browsers typically use TCP when they connect to servers on the World Wide Web and used to deliver email and transfer files from one location to another. HTTP, HTTPS, SMTP, POP3, IMAP, SSH, FTP, Telnet and a variety of other protocols that are typically encapsulated in TCP. As the transport layer of TCP/IP suite, the TCP provides a communication service at an intermediate level between an application program and the Internet Protocol (IP). Due to network congestion, traffic load balancing, or other unpredictable network behavior, IP packets can be lost, duplicated, or delivered out of order. TCP detects these problems, requests retransmission of lost data, rearranges out-of-order data, and even helps minimize network congestion to reduce the occurrence of the other problems. Once the TCP receiver has reassembled the sequence of octets originally transmitted, it passes them to the receiving application. Thus, TCP abstracts the application's communication from the underlying networking details. The TCP is utilized extensively by many of the Internet's most popular applications, including the World Wide Web (WWW), E-mail, File Transfer Protocol, Secure Shell, peer-to-peer file sharing, and some streaming media applications.

While IP layer handles the actual delivery of the data, TCP keeps track of the individual units of data transmission, called segments, which a message is divided into for efficient routing through the network. For example, when an HTML file is sent from a web server, the TCP software layer of that server divides the sequence of octets of the file into segments and forwards them individually to the IP software layer (Internet Layer). The Internet Layer encapsulates each TCP segment into an IP packet by adding a header that includes (among other data) the destination IP address. When the client program on the destination computer receives them, the TCP layer (Transport Layer) reassembles the individual segments and ensures they are correctly ordered and error free as it streams them to an application.

The TCP protocol operations may be divided into three phases. Connections must be properly established in a multi-step handshake process (connection establishment) before entering the data transfer phase. After data transmission is completed, the connection termination closes established virtual circuits and releases all allocated resources. A TCP connection is typically managed by an operating system through a programming interface that represents the local end-point for communications, the Internet socket. During the duration of a TCP connection, the local end-point undergoes a series of state changes.

Since TCP/IP is based on the client/server model of operation, the TCP connection setup involves the client and server preparing for the connection by performing an OPEN operation. A client process initiates a TCP connection by performing an active OPEN, sending a SYN message to a server. A server process using TCP prepares for an incoming connection request by performing a passive OPEN. Both devices create for each TCP session a data structure used to hold important data related to the connection, called a Transmission Control Block (TCB).

The Internet Protocol (IP) is the principal communications protocol used for relaying datagrams (packets) across a network using the Internet Protocol Suite. It is the primary protocol responsible for routing packets across the Internet. IP is the primary protocol in the Internet Layer of the Internet Protocol Suite and has the task of delivering datagrams from the source host to the destination host based on their addresses. For this purpose, IP defines addressing methods and structures for datagram encapsulation. Internet Protocol Version 4 (IPv4) is the dominant protocol of the Internet. IPv4 is described in Internet Engineering Task Force (IETF) Request for Comments (RFC) 791 and RFC 1349, and the successor, Internet Protocol Version 6 (IPv6), is currently active and in growing deployment worldwide. IPv4 uses 32-bit addresses (providing 4 billion: 4.3×10⁹ addresses), while IPv6 uses 128-bit addresses (providing 340 undecillion or 3.4×10³⁸ addresses), as described in RFC 2460.

The Internet architecture employs a client-server model, among other arrangements. The terms ‘server’ or ‘server computer’ relate herein to a device or computer (or a plurality of computers) connected to the Internet and is used for providing facilities or services to other computers or other devices (referred to in this context as ‘clients’) connected to the Internet. A server is commonly a host that has an IP address and executes a ‘server program’, and typically operates as a socket listener. Many servers have dedicated functionality such as web server, Domain Name System (DNS) server (described in RFC 1034 and RFC 1035), Dynamic Host Configuration Protocol (DHCP) server (described in RFC 2131 and RFC 3315), mail server, File Transfer Protocol (FTP) server and database server. Similarly, the term ‘client’ is used herein to include, but not limited to, a program, or to a device or a computer (or a series of computers) executing this program, which accesses a server over the Internet for a service or a resource. Clients commonly initiate connections that a server may accept. For non-limiting example, web browsers are clients that connect to web servers for retrieving web pages, and email clients connect to mail storage servers for retrieving mails.

Operating System.

An Operating System (OS) is a software that manages computer hardware resources and provides common services for computer programs. The operating system is an essential component of any system software in a computer system, and most application programs usually require an operating system to function. For hardware functions such as input, output, and memory allocation, the operating system acts as an intermediary between programs and the computer hardware, although the application code is usually executed directly by the hardware and frequently makes a system call to an OS function or be interrupted by it. Common features typically supported by operating systems include process management, interrupts handling, memory management, file system, device drivers, networking (such as TCP/IP and UDP), and Input/Output (I/O) handling. Examples of popular modern operating systems include Android, BSD, iOS, Linux, OS X, QNX, Microsoft Windows, Windows Phone, and IBM z/OS.

A server device (in server/client architecture) typically offers information resources, services, and applications to clients, and is using a server dedicated or oriented operating system. Current popular server operating systems are based on Microsoft Windows (by Microsoft Corporation, headquartered in Redmond, Wash., U.S.A.), Unix, and Linux-based solutions, such as the ‘Windows Server 2012’ server operating system is part of the Microsoft ‘Windows Server’ OS family, that was released by Microsoft on 2012, providing enterprise-class data center and hybrid cloud solutions that are simple to deploy, cost-effective, application-focused, and user-centric, and is described in Microsoft publication entitled: “Inside-Out Windows Server 2012”, by William R. Stanek, published 2013 by Microsoft Press. Server devices may further employ, store, integrate, or operate a server-oriented operating system, such as the Microsoft Windows Server® (2003 R2, 2008, 2008 R2, 2012, or 2012 R2 variant), Linux™ (or GNU/Linux) variants (such as Debian based: Debian GNU/Linux, Debian GNU/kFreeBSD, or Debian GNU/Hurd, Fedora™ Gentoo™, Linspire™, Mandriva, Red Hat® Linux available from Red Hat, Inc. headquartered in Raleigh, N.C., U.S.A., Slackware®, SuSE, or Ubuntu®), or UNIX®, including commercial UNIX® variants such as Solaris™ (available from Oracle Corporation headquartered in Redwood City, Calif., U.S.A.), AIX® (available from IBM Corporation headquartered in Armonk, N.Y., U.S.A.), or Mac™ OS X (available from Apple Inc. headquartered in Cupertino, Calif., U.S.A.), or free variants such as FreeBSD®, OpenBSD, and NetBSD®.

Unix operating systems are widely used in servers. Unix is a multitasking, multi-user computer operating system that exists in many variants, and are characterized by a modular design that is sometimes called the “Unix philosophy,” meaning the OS provides a set of simple tools that each perform a limited, well-defined function, with a unified filesystem as the main means of communication, and a shell scripting and command language to combine the tools to perform complex workflows. Unix was designed to be portable, multi-tasking and multi-user in a time-sharing configuration, and Unix systems are characterized by various concepts: the use of plain text for storing data; a hierarchical file system; treating devices and certain types of Inter-Process Communication (IPC) as files; and the use of a large number of software tools, small programs that can be strung together through a command line interpreter using pipes, as opposed to using a single monolithic program that includes all of the same functionality. Under UNIX, the operating system consists of many utilities along with the master control program, the kernel. The kernel provides services to start and stop programs, handles the file system and other common “low level” tasks that most programs share and schedules access to avoid conflicts when programs try to access the same resource (or device) simultaneously. To mediate such access, the kernel has special rights, reflected in the division between user-space and kernel-space. Unix is described in a publication entitled: “UNIX Tutorial” by tutorialspoint.com, downloaded on July 2014.

A client device (in server/client architecture) typically receives information resources, services, and applications from servers, and is using a client dedicated or oriented operating system. Current popular server operating systems are based on Microsoft Windows (by Microsoft Corporation, headquartered in Redmond, Wash., U.S.A.), which is a series of graphical interface operating systems that are developed, marketed, and sold by Microsoft. Microsoft Windows is described in Microsoft publications entitled: “Windows Internals—Part 1” and “Windows Internals—Part 2”, by Mark Russinovich, David A. Solomon, and Alex Ioescu, published by Microsoft Press in 2012. Windows 8 is a personal computer operating system developed by Microsoft as part of Windows NT family of operating systems, that was released for general availability on October 2012, and is described in Microsoft Press 2012 publication entitled: “Introducing Windows 8 —An Overview for IT Professionals” by Jerry Honeycutt. A device herein may further employ, store, integrate, or operate a client-oriented (or end-point dedicated) operating system, such as Microsoft Windows® (including the variants: Windows 7, Windows XP, Windows 8, and Windows 8.1, available from Microsoft Corporation, headquartered in Redmond, Wash., U.S.A.), Linux, and Google Chrome OS available from Google Inc. headquartered in Mountain View, Calif., U.S.A.

Cloud.

Software as a Service (SaaS) is a Software Application (SA) supplied by a service provider, namely, a SaaS Vendor. The service is supplied and consumed over the Internet, thus eliminating requirements to install and run applications locally on a site of a customer, as well as simplifying maintenance and support. Particularly it is advantageous in massive business applications. Licensing is a common form of billing for the service, and it is paid periodically. SaaS is becoming ever more common as a form of SA delivery over the Internet and is being facilitated by a technology infrastructure referred to as “Cloud Computing”. In this form of SA delivery, where a service provider controls the SA, a customer may experience stability and data security issues. In many cases, the customer is a business organization that is using the SaaS for business purposes such as business software; hence, stability and data security are primary requirements.

The term “Cloud computing”, as used herein, is defined as a technology infrastructure facilitating supplement, consumption and delivery of IT services. The IT services are internet based and may involve elastic provisioning of dynamically scalable and time virtualized resources. The term “Software as a Service (SaaS)” as used herein in this application, is defined as a model of software deployment whereby a provider licenses an SA to customers for use as a service on demand. The term “customer” as used herein in this application, is defined as a business entity that is served by an SA, provided on the SaaS platform. A customer may be a person or an organization and may be represented by a user that responsible for the administration of the application in aspects of permissions configuration, user related configuration, and data security policy.

The term “SaaS Platform”, as used herein in this application, is defined as a computer program that acts as a host to SAs that reside on it. Essentially, a SaaS platform can be considered as a type of specialized SA server. The platform manages underlying computer hardware and software resources and uses these resources to provide hosted SAs with multi-tenancy and on-demand capabilities, commonly found in SaaS applications. The hosted SAs are typically compatible with SaaS platform and support a single group of users. The platform holds the responsibility for distributing the SA as a service to multiple groups of users over the internet. The SaaS Platform can be considered as a layer of abstraction above the traditional application server, creating a computing platform that parallels the value offered by the traditional operating system, only in a web-centric fashion. The SaaS platform responds to requirements of software developers. The requirements are to reduce time and difficulty involved in developing highly available SAs, and on-demand enterprise grade business SAs.

Database.

A database is an organized collection of data, typically managed by a DataBase Management System (DBMS) that organizes the storage of data and performs other functions such as the creation, maintenance, and usage of the database storage structures. The data is typically organized to model aspects of reality in a way that supports processes requiring information. Databases commonly also provide users with a user interface and front-end that enables the users to query the database, often in complex manners that require processing and organization of the data. The term “database” is used herein to refer to a database, or to both a database and the DBMS used to manipulate it. Database management systems (DBMS) are typically computer software applications that interact with the user, other applications, and the database itself to capture and analyze data, typically providing various functions that allow entry, storage and retrieval of large quantities of information, as well as providing ways to manage how that information is organized. A general-purpose DBMS is designed to allow the definition, creation, querying, update, and administration of databases. Examples of DBMSs include MySQL, PostgreSQL, Microsoft SQL Server, Oracle, Sybase and IBM DB2. Database technology and application is described in a document published by Telemark University College entitled “Introduction to Database Systems”, authored by Hans-Petter Halvorsen (dated 2014 Mar. 3).

SQL.

Structured Query Language (SQL) is a widely-used programming language for working with relational databases, designed for managing data held in a relational database management system (RDBMS), or for stream processing in a relational data stream management system (RDSMS). SQL consists of a data definition language and a data manipulation language. The scope of SQL includes data insert, query, update and delete, schema creation and modification, and data access control. Although SQL is often described as, and largely is, a declarative language (4GL), it also includes procedural elements. SQL is designed for querying data contained in a relational database, and is a set-based, declarative query language. The SQL is standardized as ISO/IEC 9075:2011 standard: “Information technology-Database languages-SQL”. The ISO/IEC 9075 standard is complemented by ISO/IEC 13249 standard: “SQL Multimedia and Application Packages” that defines interfaces and packages based on SQL. The aim is a unified access to typical database applications like text, pictures, data mining or spatial data. SQL is described in the tutorial entitled: “Oracle/SQL Tutorial” by Michael Gertz of University of California.

“Personally Identifiable Information” (PII), as used in US privacy law and information security, is information that can be used on its own or with other information to identify, contact, or locate a single person, or to identify an individual in context. The PII may refer to any information that can be used to distinguish or trace an individual's identity, such as name, U.S. Social Security Number (SSN), date and place of birth, mother's maiden name, or biometric records, or any other information that is linked or linkable to an individual, such as medical, educational, financial, and employment information. While some attributes may be uniquely identifying on their own, an attribute can be identifying in combination with others.

Examples of PII that can be used on its own to identify, contact, or locate a single person, or to identify an individual in context, includes government (such as government agency) or corporate issued number such as National identification number, Social Security Number (SSN), Driver license number, passport number, taxpayer identification number, or financial account, association/club member number or employee number; a device or service identification such as an IP address, Email address, telephone number, or vehicle registration plate number; a physical address (such as an individual residing in a single family home). Examples of attributes that can be identifying in combination with others include date of birth, birthplace, first or last name (if common), country, state, city, or street of residence, age, gender, or race, mother's maiden name, name of the school attended or workplace, grades, salary, or job position, as well as race, religion, weight, height, activities, geographical indicators, employment information, medical information, education information, and financial information. Further, any range relating to any former attribute may be used for identifying in combination with others, such as last few digits of an identifying number (such as Social Security Number (SSN) or Driver license number), of few letters from a textual-based name such as the first two letters of a name or street address.

Identity theft is a form of stealing someone's identity in which someone pretends to be someone else by assuming that person's identity, usually as a method to gain access to resources or obtain credit and other benefits in that person's name. The victim of identity theft (here meaning the person whose identity the identity thief has assumed) can suffer adverse consequences if they are held responsible for the perpetrator's actions. Identity theft occurs when someone uses another's personally identifying information, like their name, identifying number, or credit card number, without their permission, to commit fraud or other crimes.

The escalation of security breaches involving personally identifiable information (PII) has contributed to the loss of millions of records over the past few years. Breaches involving PII are hazardous to both individuals and organizations. Individual harms may include identity theft, embarrassment, or blackmail. Organizational harms may include a loss of public trust, legal liability, or remediation costs. Guidelines for a risk-based approach to protecting the confidentiality of PII are described in NIST (National Institute of Standards and Technology) Special Publication 800-122 dated April 2010 entitled: “Guide to Protecting the Confidentiality of Personally Identifiable Information (PII)”.

The problem of protecting PII is particularly relevant to cloud or Internet based storage, and the cloud databases continuously serve as targets for hackers. For example, on Jul. 31, 2012, Dropbox announced that an employee's account had been hacked, resulting in a number of Dropbox users being spammed by email. Further, beginning Aug. 31, 2014, a collection of almost 500 private pictures of various celebrities—mostly consisting of women, and with many containing nudity, were posted on the imageboard, and later disseminated by other users on websites and social networks such as Imgur, Reddit and Tumblr. The images were believed to have been obtained via a breach of Apple's cloud services suite iCloud.

In order to prohibit the disclosure or misuse of information held on private individuals, various countries have coded information privacy or data protection laws. The basic principles of data protection are typically that for all data collected there should be a stated purpose, information collected by an individual cannot be disclosed to other organizations or individuals unless authorized by law, or by a consent by the individual, records kept on an individual should be accurate and up to date, there should be mechanisms for individuals to review data about them, to ensure accuracy and this may include periodic reporting, and some data is too sensitive to be collected, unless there are extreme circumstances (e.g., sexual orientation, religion).

PIN.

A Personal Identification Number (PIN) is a numeric password shared between a user and a system that can be used to authenticate the user to the system. Typically, the user is required to provide a non-confidential user identifier or token (the user ID) and a confidential PIN to gain access to the system. Upon receiving the user ID and the PIN, the system looks up the PIN-based or the user ID and compares the looked-up PIN with the received PIN. The user is granted access only when the number entered matches with the number stored in the system. Hence, despite the name, a PIN does not personally identify the user.

PINs are commonly used with banking systems (where the identifying token is a card), but are also used in other, non-financial systems. The PIN is not printed or embedded on the card but is manually entered by the cardholder during Automated Teller Machine (ATM) and Point-of-Sale (POS) transactions (such as those that comply with EMV), and in card not present transactions, such as over the Internet or for phone banking. PINs may also be used in contexts other than ATM or POS transactions, such as for door access, Internet transactions, or to log in to a restricted website. In such cases, the PIN may simply be a password, and not necessarily associated with a specific card. In banking systems, PIN management and security are governed by international standard ISO 9564.

A system and method of biometric-based age verification for authorizing presenter access of age-restricted good or services between an age presenter and an age verifier is described in U.S. Patent Application Publication No. 2003/0177102 to Robinson entitled: “System and Method for Biometric Authorization for Age Verification”.

In the described method, system presenters register at least one biometric identifier, at least one identification number, personal age-verifying data, and personal identity-verifying data. A presenter presents a biometric sample obtained from the presenter's person and the presenter's system ID number to conduct age verifications for purchase of or access to age-restricted goods or services. This data is used to authenticate the presenter's age and authorize access to purchase or obtain age-restricted goods or services by matching the presented transaction biometric with at least one registered biometric template and without the use of a man-made identity token.

A method for identifying a biometric record of an individual in a database is described in U.S. Patent Application Publication No. 2013/0093565 to Partington et al., entitled: “Biometric Matching System”. The database comprises a plurality of biometric records, each record comprising at least one reference biometric sample, and using a biometric identification unit the method comprising of receiving an input biometric sample with associated source information; and selecting a matching process using a reference table, and based on said source information. Then, the method comprising of applying, by a said selected matching process to at least some of said biometric records of said database, to determine whether said input biometric sample matches a reference biometric sample of one of said biometric records.

The use of an anonymous biometric authentication system and method that use biometrics to anonymously authenticate an individual and grant certain privileges based on the anonymous authentication is described in U.S. Patent Application Publication No. 2002/0112177 to Voltmer et al., entitled: “Anonymous Biometric Authentication”. The system and method permit enrollment of an individual by submission of a first biometric and associated identity documents or credentials to an enrollment authority. The enrollment authority verifies the identity of the identity of the individual submitting the biometric using the credentials that are then returned to the individual or discarded. The first biometric is stored in a database for later retrieval in anonymously authenticating an individual seeking to exercise certain privileges. No other personal identity information is stored along with the biometric during the enrollment process. When an individual later seek to exercise certain privileges, he must submit a second biometric, that is compared to the stored biometrics in the database, in order to anonymously authenticate the identity of the individual as having access to such privileges. No other personal information is captured, collected, or solicited during the authentication process. Privileges are granted to an individual based on the comparison of the later captured biometric to the stored biometrics in the database. Alternatively, the anonymous biometric authentication system can be designed to avoid repeat offenders by capturing a biometric of an individual seeking to exercise a privilege and denying the privilege if the captured biometric is matched to a biometric stored in a database containing the biometrics of previous offenders. Preferably, the system and method include capture and storage of a powerful biometric identifier based on the iris of the eye which uniquely identifies the individual that has submitted the biometric. Anonymous biometric authentication allows verification of the identity of an individual seeking certain privileges while at the same time protecting the privacy of personal information about the individual.

A method of identifying a biometric record of an individual in a database having a plurality of biometric records is described in a U.S. Patent Application Publication No. 2013/0083975 to Partington et al., entitled: “Biometric Training and Matching Engine”. The method involves during a training phase the steps of applying by a processing device a matching operation to determine scores for a similarity between at least one training biometric sample of each of a plurality of training records and at least one probe sample; and based on said scores, determining a threshold value. During an identification phase, the method comprises the steps of evaluating at least one reference biometric sample of each of the records in said database, to determine a parameter value for each record; selecting a subset of said records by comparing each of said parameter values with said threshold value, and applying a matching operation to the selected records to determine whether an input biometric sample matches a reference biometric sample of one of said selected records.

Systems and methods for social networks that can verify that enrolled users are not misrepresenting facts about themselves such as age and gender are described in U.S. Pat. No. 8,185,646 to Headley entitled: “User Authentication for Social Networks”. A verification can be performed, for example, by reference to biometric templates stored during the user enrollment process. The biometric templates can be used to authenticate users logging into the social network to prevent user impersonation. The ability of some users to communicate to other users of the social network can be limited to only certified users, and even to those certified users that match a criterion, such as gender or age.

A biometric registration and verification system and method is usable for registration, for verification and/or for participation is described in a U.S. Patent Application Publication No. 2013/0251214 to Chung entitled: “Biometric Registration and Verification System and Method”. The method involves a biometric sensor for capturing biometric data; a data entry device, a computer processor for receiving captured biometric data and entered data; and a database storing records thereof. The identifying biometric data may be related to the entered data in the database record. The biometric sensor may capture verification biometric data and the data entry verification data; and the processor compares the verification biometric data and the received verification data with the identifying biometric data and entered data from the database. If the verification biometric data and the received verification data of the person to be verified correspond to the database identifying biometric data and the entered data, then an indication of verification of the person is provided.

A data processing device and a related method are described in Chinese Patent Publication No. CN 101499018 to Yu, entitled: “Data Processing Unit and Method”. The device comprises a memory module for storing the characteristics (including the characteristics of data for each parameter—including gender or age parameters); a capture module for capturing the user's facial image and extraction from facial images the user's gender-related information or age; and a matching module used to match sex information and sex or age parameters. The implementation of modules for use in accordance with the results of the implementation of the relevant match.

In consideration of the foregoing, it would be an advancement in the art to provide an anonymous database solution and other method and system for improving functionalities, that are simple, secure, cost-effective, load-balanced, redundant, reliable, provide lower CPU and/or memory usage, easy to use, reduce latency, faster, has a minimum part count, minimum hardware, and/or uses existing and available components, protocols, programs and applications for providing better quality of service, overload avoidance, better or optimal resources allocation, better communication and additional functionalities, and provides a better user experience.

### SUMMARY

A non-transitory tangible computer-readable storage medium may be storing a database that comprises a plurality of records associated with a first group of individuals, where each record is uniquely identified by a respective record identifier and is associated with a single individual from the group. The respective individual information in at least one record may consist of at least one biometric template associated with the individual associated with the record; and a set of traits of the individual associated with the record, wherein the set of traits identifies a second group of multiple individuals. A record may consist of two more biometric template associated with the individual associated with the record. Alternatively or in addition, the respective individual information in each of all the records in the database may consist of at least one biometric template associated with the individual associated with the record; and a set of traits of the individual associated with the record; wherein the set of traits identifies multiple individuals that are part of a second group of multiple individuals. The second group may consist of, comprise, or may be included in, the first group of individuals, or may consist of multiple individuals residing in a location, wherein the location is a street, a ZIP code, a city, a state, or a country. The number of individuals in the second group may be at least 5, 10, 50, 100, 500, or 1000.

A method may be used for creating and storing the record associated with an individual in the database that is part of, or connected to, a server device. The server device may be communicating over the Internet with a client device that may include, or may connect to, the biometric sensor and a text input interface. The method may be comprising the steps of capturing, by the biometric sensor, a biometric data of the individual; capturing, by the text input interface, a set of traits of the individual; sending, by the client device, the captured biometric data or a representation thereof, and the set of traits, to the server device over the Internet; creating, by the server, a record including the captured biometric data or a representation thereof, and the set of traits, received from the client device; and storing in the database the created record, wherein the set of traits identifies a second group of multiple individuals. The set of traits may identify a group of multiple individuals.

The client device may send the captured biometric data, or a biometric template that is unique to the captured biometric data, to the server device. The text input interface may be a keyboard or a pointing device. The client device may include or may connect to, multiple biometric sensors, and the captured biometric data may include biometric data captured from the multiple biometric sensors.

A method is described for controlling access of an individual to a resource based on the database that may be part of, or may be connected to, a server device. The database may be storing the record associated with the individual and including the first biometric data or representation thereof and the set of traits, the server device is communicating over the Internet with a client device that includes, or connects to, a biometric sensor and a text input interface. The method may comprise the steps of capturing, by the biometric sensor, a second biometric data of the individual; sending, by the client device, the second captured biometric data or a representation thereof, to the server device over the Internet; fetching, by the server device, the record associated with the individual; comparing, by the server device, the first biometric data or the representation thereof to the received second captured biometric data or a representation thereof; determining, by the server device, whether the first biometric data or the representation thereof and the received second captured biometric data or a representation thereof are of the same person; and in response to determining that the first and second biometric data or the representation thereof are not of the same person, sending, by the server device, a message to the client device over the Internet.

The method may include the step of in response to determining that the first and second biometric data or the representation thereof are of the same person, sending part of, or whole of, the set of traits to the client device. The client device may be sending a biometric template that is unique to the second captured biometric data to the server device. The set of traits may identify a group of multiple individuals. Each record may be associated with a unique record identifier, and the method may further comprise the step of sending, by the client device, the record identifier to the server device, and wherein the server device uses the record identifier for fetching the record. The method may further comprise the step of in response to determining that the first and second biometric data or their representation are of the same person, sending, by the server device, part or all of the set of traits of the fetched record to the client device over the Internet. Alternatively or in addition, the method may further comprise the step of in response to determining that the first and second biometric data or their representation are of the same person, checking whether one of the traits included in set of traits satisfies a criterion.

The trait may be a discrete trait value, and the criterion may include checking, by the server or client device, if the discrete trait value is part of a group including one or more discrete trait values. The method may be for use with a maximum value or a minimum value wherein the trait value may be a continuous numerical value and the criteria may be satisfied when the value is respectively below the maximum value or above the minimum value. Further, upon determining that the criterion is satisfied, an action may be initiated by the client device, and the action may be associated with physical access control, such as allowing access to a physical resource, or the action may be associated with access control to information, or with logging to an Internet-based service, such as chat room or Internet forum.

The biometric template may be a distinct and measurable human characteristics, and may consist of, include, or may be based on, an input captured from the respective record individual by a biometric sensor, and the human characteristics are physiological characteristics. The biometric sensor may be a fingerprints reader or scanner, and the captured input may be a fingerprint pattern or image, and the fingerprints reader or scanner may be optical imaging based using a visible or an invisible light, may be ultrasonic imaging based, or may be capacitance imaging based. Alternatively or in addition, the biometric sensor may be a hand geometry reader, and the captured input may be a hand geometry pattern or image. Alternatively or in addition, the biometric sensor may be an eye iris camera, the captured input is an eye iris pattern or image, and the eye iris camera may be using Near Infrared (NIR) wavelength band or Visible Wavelength (VW) band. Alternatively or in addition, the biometric sensor may be a vascular scanner that includes a camera and a light source, and the captured input may be a palm, finger, or eye vein pattern or image. Alternatively or in addition, the biometric sensor may be a digital camera, and the captured input is a face pattern or image. Alternatively or in addition, the human characteristics may be behavioral characteristics, where the biometric template may be based on Personal Identification Number (PIN), signature or handwritten recognition, keystroke recognition, or voice/speech recognition. The set of traits may include a trait that may be selected from a group, and may be a born trait that is the respective individual gender, race, ethnicity, skin color, hair color, or eye color. Alternatively or in addition, the trait may be a continuous variable trait that is according to, or based on, the respective individual age, weight, or height. The database is a relational database system that may be Structured Query Language (SQL) based. A server device may include, store, or may be connected to, the non-transitory tangible computer-readable storage medium, and the server may further be connected to a digital network such as the Internet for receiving or transmitting the records.

Any server herein, such as the verification server or the service server, may be storing, operating, or using, a server operating system, that may consist of, be comprises of, or may be based on, Microsoft Windows Server®, Linux, or UNIX. Alternatively or in addition, the server operating system may consist of, may comprise, or may be based on, Microsoft Windows Server® 2003 R2, 2008, 2008 R2, 2012, or 2012 R2 variant, Linux™ or GNU/Linux based Debian GNU/Linux, Debian GNU/kFreeBSD, Debian GNU/Hurd, Fedora™, Gentoo™, Linspire™, Mandriva, Red Hat® Linux, SuSE, and Ubuntu®, UNIX® variant Solaris™, AIX®, Mac™ OS X, FreeBSD®, OpenBSD, or NetBSD®. Any client device herein, such as an access station or enrollment station, may be storing, operating, or using, a client operating system that may consist of, may comprise, or may be based on, Microsoft Windows 7, Microsoft Windows XP, Microsoft Windows 8, Microsoft Windows 8.1, Linux, and Google Chrome OS. The client operating system may be a mobile operating system that may consist of, may comprise, or may be based on, Android version 2.2 (Froyo), Android version 2.3 (Gingerbread), Android version 4.0 (Ice Cream Sandwich), Android Version 4.2 (Jelly Bean), Android version 4.4 (KitKat)), Apple iOS version 3, Apple iOS version 4, Apple iOS version 5, Apple iOS version 6, Apple iOS version 7, Microsoft Windows® Phone version 7, Microsoft Windows® Phone version 8, Microsoft Windows® Phone version 9, or Blackberry® operating system. A client device may include a web browser, which may consist of, may comprise, or may be based on, Microsoft Internet Explorer, Google Chrome, Opera™, or Mozilla Firefox®. The web browser may be a mobile web browser that may consist of, may comprise, or may be based on, Safari, Opera Mini™, or Android web browser.

Any method herein may further comprise the step of intercepting a request for content by a network element, such as the intercepting of the request for the first content by the first device. The request may be initiated in an application (that may be a communications application such as a TCP/IP or HTTP/HTTPS handling application) in a network element such as the first device. The interception may be in the form of a plug-in or an extension of the application, may be by hooking to the application, may be in a filter driver form, or may be using Inter-Process Communication (IPC). The IPC may be using a file sharing, a signal, a socket, a pipe, a message queue, a shared memory, a semaphore, memory mapped file, a clipboard, a Component Object Model (COM), a data copy, a DDE protocol, or mailslots. The application may be a web browser that may be consisting of, comprising of, or may be based on, Microsoft Internet Explorer, Google Chrome, Opera™, or Mozilla Firefox®. Alternatively or in addition, the web browser may be a mobile web browser, which consists of, comprises of, or is based on, Safari, Opera Mini™ or Android web browser.

A tangible machine-readable medium (such as a storage) may have a set of instructions detailing part (or all) of the methods and steps described herein stored thereon, so that when executed by one or more processors, may cause the one or more processors to perform part of, or all of, the methods and steps described herein. Any of the network elements may be a computing device that comprises a processor and a computer-readable memory (or any other tangible machine-readable medium), and the computer-readable memory may comprise computer-readable instructions such that, when read by the processor, the instructions causes the processor to perform the one or more of the methods or steps described herein. A non-transitory computer readable medium containing computer instructions that, when executed by a computer processor, cause the processor to perform at least part of the steps described herein.

The above summary is not an exhaustive list of all aspects of the present invention. Indeed, it is contemplated that the invention includes all systems and methods that can be practiced from all suitable combinations and derivatives of the various aspects summarized above, as well as those disclosed in the detailed description below and particularly pointed out in the claims filed with the application. Such combinations have particular advantages not specifically recited in the above summary.

### BRIEF DESCRIPTION OF THE DRAWINGS

The invention is herein described, by way of non-limiting examples only, with reference to the accompanying drawings, where like designations denote like elements. Understanding that these drawings only provide information concerning typical embodiments and are not therefore to be considered limiting in scope:

FIG. 1 illustrates schematically a block diagram of a computer;

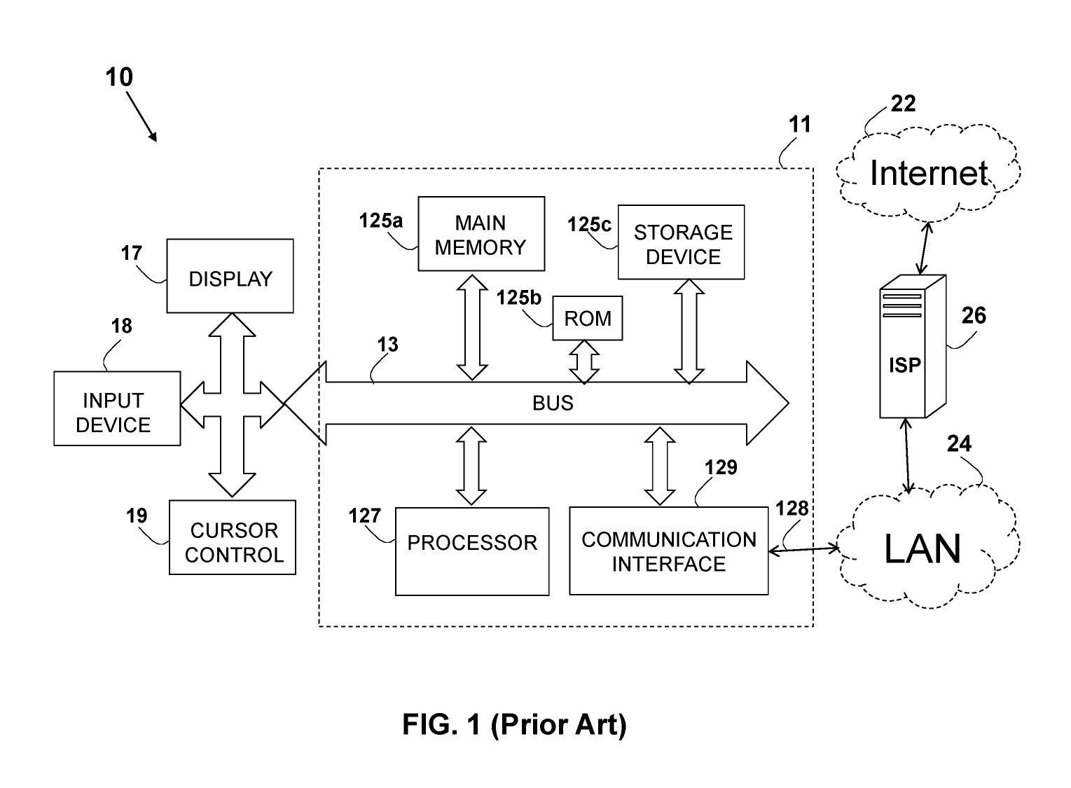

FIG. 2 illustrates schematically a block diagram of Internet and servers, client, and a computer workstation connected to the Internet;

FIG. 3 illustrates schematically a block diagram of an arrangement for creating, updating, and using an anonymous biometrics database;

FIG. 3a illustrates schematically a block diagram of an arrangement for creating, updating, and using an anonymous biometrics database using a kiosk and fingerprints reader;

FIG. 4 illustrates schematically an example of an anonymous biometrics database;

FIG. 5 depicts schematically a flow diagram of creating or updating an anonymous biometrics database;

FIG. 6 depicts schematically a flow diagram of using an anonymous biometrics database;

FIG. 6a depicts schematically a flow diagram of using an anonymous biometrics database for decision regarding taking an action;

FIG. 7 illustrates schematically a block diagram of an arrangement using an anonymous biometrics database for a physical security application of access control;

FIG. 8 illustrates schematically a block diagram of an arrangement using an anonymous biometrics database for a remote server access control;

FIG. 8a depicts schematically messages exchanged over the Internet between network elements in an arrangement using an anonymous biometrics database for a remote server access control; and

FIG. 9 depicts schematically a flow diagram of using an anonymous biometrics database for a remote server access control.

### DETAILED DESCRIPTION

The principles and operation of an apparatus or a method according to the present invention may be understood with reference to the figures and the accompanying description wherein identical or similar components (either hardware or software) appearing in different figures are denoted by identical reference numerals. The drawings and descriptions are conceptual only. In actual practice, a single component can implement one or more functions; alternatively or in addition, each function can be implemented by a plurality of components and devices. In the figures and descriptions, identical reference numerals indicate those components that are common to different embodiments or configurations. Identical numerical references (in some cases, even in the case of using different suffix, such as 5, 5a, 5b and 5c) refer to functions or actual devices that are either identical, substantially similar, similar, or having similar functionality. It is readily understood that the components of the present invention, as generally described and illustrated in the figures herein, could be arranged and designed in a wide variety of different configurations. Thus, the following more detailed description of the embodiments of the apparatus, system, and method of the present invention, as represented in the figures herein, is not intended to limit the scope of the invention, as claimed, but is merely representative of embodiments of the invention. It is to be understood that the singular forms “a,” “an,” and “the” herein include plural referents unless the context clearly dictates otherwise. Thus, for example, reference to “a component surface” includes reference to one or more of such surfaces. By the term “substantially” it is meant that the recited characteristic, parameter, or value need not be achieved exactly, but that deviations or variations, including, for example, tolerances, measurement error, measurement accuracy limitations and other factors known to those of skill in the art, may occur in amounts that do not preclude the effect the characteristic was intended to provide.

Biometrics refers to metrics related to human characteristics biometrics authentication (or realistic authentication) is used as a form of identification and access control, as well as for identifying individuals in groups that are under surveillance. Biometric identifiers are the distinctive, measurable characteristics used to label and describe individuals and are commonly categorized as physiological versus behavioral characteristics. Physiological characteristics are related to the shape of the body, such as fingerprint, palm veins, face recognition, DNA, palm print, hand geometry, iris recognition, retina, and odour/scent. Behavioral characteristics (a.k.a. behaviometrics) are related to the pattern of behavior of a person, including but not limited to typing rhythm, gait, and voice. Since biometric identifiers are unique to individuals, they are more reliable for verifying identity than token and knowledge-based methods; however, the collection of biometric identifiers raises privacy concerns about the ultimate use of this information.

Many different aspects of human physiology, chemistry or behavior may be used for biometric authentication. The selection of a particular biometric for use in a specific application involves a weighting of several factors. A trait for use in biometric authentication is typically universal, meaning that every person using a system should possess the trait; unique, meaning that the trait should be sufficiently different for individuals in the relevant population such that they can be distinguished from one another; permanent, relating to the manner in which a trait varies over time; measurable or collectable, relating to the ease of acquisition or measurement of the trait; and not susceptible for circumvention, relating to the ease with which a trait might be imitated using an artifact or substitute.

Two basic modes of operation of a biometric system are commonly defined, namely a verification mode and an identification mode. First, in verification (or authentication) mode the system performs a one-to-one comparison of a captured biometric with a specific template stored in a biometric database in order to verify the individual is the person they claim to be. Three steps are involved in the verification of a person: First, reference models for all the users are generated and stored in the model database. Second, some samples are matched with reference models to generate the genuine and impostor scores and calculate the threshold, and then is the testing step. This process may use a smart card, username or ID number (e.g. PIN) to indicate which template should be used for comparison. ‘Positive recognition’ is a common use of the verification mode, where the aim is to prevent multiple people from using the same identity. In the identification mode, the system performs a one-to-many comparison against a biometric database in attempt to establish the identity of an unknown individual. The system will succeed in identifying the individual if the comparison of the biometric sample to a template in the database falls within a previously set threshold. Identification mode can be used either for ‘positive recognition’ so that the user does not have to provide any information about the template to be used or for ‘negative recognition’ of the person where the system establishes whether the person is who she (implicitly or explicitly) denies being. The latter function can be only achieved through biometrics since other methods of personal recognition such as passwords, PINs or keys are ineffective.

The first time an individual uses a biometric system is commonly referred to as enrollment, during which biometric information from an individual is captured and stored. In subsequent uses, biometric information is detected and compared with the information stored at the time of enrollment. A biometric sensor serves the interface between to acquire all the necessary biometric data. Then the necessary pre-processing is performed on the captured data, typically to remove artifacts from the sensor, to enhance the input (e.g., removing background noise), and to use some normalization. Then the necessary features are extracted. A vector of numbers, an image, or other data type with particular properties, is used to create a template, which is a synthesis of the relevant characteristics extracted from the source. Elements of the biometric measurement that are not used in the comparison algorithm are discarded in the template to reduce the file-size and to protect the identity of the enrollee.

During the enrollment phase, the template is simply stored somewhere (on a card or within a database or both), while during the matching phase, the obtained template is passed to a matcher that compares it with other existing templates, estimating the distance between them using any algorithm (e.g., Hamming distance). The matching program will analyze the template with the input, that then be used as output for any specified use or purpose (e.g., entrance in a restricted area). Performance, Acceptability, Circumvention, Robustness, Population coverage, Size, Identity theft are used for selecting a particular biometric.

Biometric technologies, methods and applications are described in “Biometric Technology Application Manual-Volume One: Biometric Basics” and “Biometric Technology Application Manual-Volume 2: Applying Biometrics [Draft Version]” published 2008 by National Biometric Security Project (NBSP), in an article entitled: “A survey of Biometric Recognition Methods”, by Kresimir Delac and Mislay Grgic of Croatia, published in the 46^{th} International Symposium Electronics in Marine, ELMAR-2004, in a MITRE technical report entitled: “State of the Art Biometrics Excellence Roadmap—Technology Assessment: Volume 1 (of 3)—Fingerprint, Palm print, Vascular, Standards”, v1.2 Oct. 2008, in a MITRE technical report entitled: “State of the Art Biometrics Excellence Roadmap—Technology Assessment: Volume 2 (of 3)—Face, Iris, Era, Voice, and handwritten Recognition”, v1.3 Mar. 2009, and in a MITRE technical report entitled: “State of the Art Biometrics Excellence Roadmap—Technology Assessment: Volume 3 (of 3) DNA”, March 2009.

Multimodal biometric systems use multiple sensors or biometrics to overcome the limitations of unimodal biometric systems. For instance, iris recognition systems can be compromised by aging irides, and finger-scanning systems may be compromised by worn-out or cut fingerprints. While unimodal biometric systems are limited by the integrity of their identifier, it is unlikely that several unimodal systems will suffer from identical limitations. Multimodal biometric systems can obtain sets of information from the same marker (i.e., multiple images of an iris, or scans of the same finger) or information from different biometrics (requiring fingerprint scans and, using voice recognition, a spoken pass-code). Multimodal biometric systems can integrate these unimodal systems sequentially, simultaneously, a combination thereof, or in series, which refer to sequential, parallel, hierarchical and serial integration modes, respectively. The information fusion is commonly divided into three parts, pre-mapping fusion, midst-mapping fusion, and post-mapping fusion/late fusion. In pre-mapping fusion, information can be combined at the sensor level or feature level. Sensor-level fusion can be mainly organized into three classes: (1) single sensor-multiple instances, (2) intra-class multiple sensors, and (3) inter-class multiple sensors. Feature-level fusion can be mainly organized into two categories: (1) intra-class and (2) inter-class. Intra-class is again classified into four subcategories: (a) Same sensor-same features, (b) Same sensor-different features, (c) Different sensors-same features, and (d) Different sensors-different features.

Multimodal biometric technologies, systems and methods are described in an article entitled: “Multi Modal Biometrics: An Overview” by Kevin W. Bowyer et al., in an article entitled: “Multi Modal Biometric Systems: A State of the Art Survey” by Fakhreddine Karray et al., of University of Waterloo, Waterloo, Canada, in an article entitled: “Multimodal Biometrics: An Overview” by Arun Ross and Anil K. Jain published in Proc. of 12^{th} European Signal Processing Conference (EUSIPCO), and in an article entitled: “Multimodal Biometric Systems—Study to Improve Accuracy and Performance” by K. Sasidhar et al., published in Vol. 1 No. 2 of the International Journal of Computer Science & Engineering Survey (UCSES) on November 2010.

Fingerprint.

Fingerprint recognition or fingerprint authentication refers to the automated method of verifying a match between two human fingerprints. The analysis of fingerprints for matching purposes commonly requires the comparison of several features of the print pattern. These include patterns, which are aggregate characteristics of ridges, and minutia points, which are unique features found within the patterns. The three basic patterns of fingerprint ridges are arch, loop, and whorl, where the arch refers to the ridges enter from one side of the finger, rise in the center forming an arc, and then exit the other side of the finger, the loop refers to the ridges enter from one side of a finger, form a curve, and then exit on that same side, and the whorl refers to the ridges form circularly around a central point on the finger.

The major minutia features of fingerprint ridges are ridge ending, bifurcation, and short ridge (or dot). The ridge ending is the point at which a ridge terminates, bifurcations are points at which a single ridge splits into two ridges, and short ridges (or dots) are ridges, which are significantly shorter than the average ridge length on the fingerprint. Minutiae and patterns are used in the analysis of fingerprints since no two fingers have been shown to be identical. A fingerprint sensor, such as a fingerprint reader or scanner, is an electronic device used to capture a digital image of the fingerprint pattern, which is digitally processed to create a biometric sample or template (a collection of extracted features) which is stored and used for matching. An example of a fingerprint sensor is Futronic FS88 that is a USB-connected optical-based fingerprint scanner available from Futronic Technology Company Limited of Kwai Fong, N. T. Hong Kong, described in a datasheet entitled: “Futronic FS88 FIPS201.PIV Compliant USB2.0 Fingerprint Scanner”. Matching algorithms are typically used to compare previously stored templates of fingerprints against candidate fingerprints for authentication purposes. Pattern-based algorithms are commonly used to compare the basic fingerprint patterns (arch, whorl, and loop) between a previously stored template and a candidate fingerprint.

Optical fingerprint imaging involves using a specialized digital camera for capturing a digital image of the print using visible or invisible light. The top layer of the sensor, where the finger is placed, is known as the touch surface, and beneath the top layer, there is a light-emitting phosphor layer that illuminates the surface of the finger. The light reflected from the finger passes through the phosphor layer to an array of solid-state pixels (typically a charge-coupled device) which captures a visual image of the fingerprint.

Ultrasonic fingerprint sensors make use of the principles of medical ultrasonography in order to create visual images of the fingerprint, and use very high-frequency sound waves to penetrate the epidermal layer of skin. The sound waves are generated using piezoelectric transducers and reflected energy is measured using piezoelectric materials. The dermal skin layer exhibits the same characteristic pattern of the fingerprint, so that the reflected wave measurements may be used to form an image of the fingerprint.

Capacitance fingerprint sensors use principles associated with capacitance in order to form fingerprint images, where a sensor array pixels each act as one plate of a parallel-plate capacitor, the dermal layer (which is electrically conductive) acts as the other plate, and the non-conductive epidermal layer acts as a dielectric.

Fingerprint capturing and recognition are described in U.S. Pat. No. 6,983,062 to Smith entitled: “Fingerprint Scanner Auto-Capture System and Method”, in U.S. Pat. No. 7,272,247 to Hamid entitled: “Method and System for Fingerprint Authentication”, in U.S. Pat. No. 6,744,910 to McClurg et al., entitled: “Hand-held fingerprint scanner with on-board image normalization data storage”, in U.S. Pat. No. 7,190,817 to Schneider et al., entitled: “Mobile Fingerprint Scanner and Docking Station”, in U.S. Pat. No. 8,564,653 to Mitchell, entitled: “Scaleable, Compact, High Resolution Optical Fingerprint Reader”, and in U.S. Pat. No. 8,810,367 to Mullins, entitled: “Electronic Device with Multimode Fingerprint Reader”.

Hand Geometry.

Hand geometry is a biometric technology that identifies users by the shape of their hands. Hand geometry readers measure a user hand along many dimensions and compare those measurements to the measurements stored in a file. Common applications include access control and time-and-attendance operations. Hand geometry is considered very reliable when combined with other forms of identification, such as identification cards or personal identification numbers. An example of a hand geometry reader is Honeywell™ HandKey II HG4-II designed to work in conjunction with card based access control systems, available from Honeywell Systems Group headquartered in Oak Creek, Wis., U.S.A., described in a datasheet entitled: “HandKey™-hand Geometry Readers”.

Hand geometry technologies and applications are further described in National Science and Technology Council (NSTC)—Subcommittee on Biometrics paper entitled: “Hand Geometry” (Last updated 7 Aug. 2006) available for download from www.biometrics.gov, and in an article by Nidhi Saxena et al., published in the International Journal of Soft Computing and Engineering (USCE) (ISSN: 2231-2307, Volume—2, Issue—6, Jan. 2013). Hand geometry capturing and recognition are described in U.S. Pat. No. 6,628,810 to Harkin entitled: “Hand Biometrics Sensing Device”, and in U.S. Pat. No. 7,428,319 to Bezvershenko et al., entitled: “Identification of a Person Based on Ultra-Sound Scan Analyses of Hand Bone Geometry”.

Iris Scanning.

Iris recognition is a method of biometric identification that uses mathematical pattern-recognition techniques on video images captured by a camera of one or both of the irises of eyes of an individual, whose complex random patterns are unique, stable, and can be seen from some distance. Retina scanning, a different, now obsolete, ocular-based biometric technology for which iris recognition is often confused with has been supplanted by iris recognition. Iris recognition uses video camera technology with subtle near infrared illumination to acquire images of the detail-rich, intricate structures of the iris that are visible externally. Digital templates encoded from these patterns by mathematical and statistical algorithms allow the identification of an individual. Databases of enrolled templates are searched by matcher engines at speeds measured in the millions of templates per second per (single-core) CPU, and with remarkably low false match rates. A key advantage of iris recognition, besides its speed of matching and its extreme resistance to false matches is the stability of the iris as an internal and protected, yet externally visible organ of the eye.

Typical iris recognition systems acquire images of an iris while being illuminated by light in the Near InfraRed wavelength band (NIR: 700-900 nm) of the electromagnetic spectrum. The majority of persons worldwide have “dark brown eyes”, the dominant phenotype of the human population, revealing less visible texture in the Visible Wavelength (VW) band but appearing richly structured, like the cratered surface of the moon, in the NIR band. Using the NIR spectrum also enables the blocking of corneal specular reflections from a bright ambient environment, by allowing only those NIR wavelengths from the narrow-band illuminator back into the iris camera.

An iris-recognition algorithm can commonly identify up to 200 identification points including rings, furrows and freckles within the iris. The system initially localizes the inner and outer boundaries of the iris (pupil and limbus) in an image of an eye, and then subroutines detect and exclude eyelids, eyelashes, and specular reflections that often occlude parts of the iris. The set of pixels containing only the iris, normalized by a rubber-sheet model to compensate for pupil dilation or constriction, is then analyzed to extract a bit pattern encoding the information needed to compare two iris images. An example of an iris camera is Iritech, Inc. IriMagic™ Auto-Capture Binocular Iris Camera series, available from Iritech Incorporated headquartered in Fairfax, Va., U.S.A., described in a datasheet entitled: “IriMagic™ Series—Auto-Capture Iris Camera”.

Iris recognition technologies and applications are described in U.S. Pat. No. 4,641,349 to Flom et al., entitled: “Iris Recognition System”, in U.S. Pat. No. 5,291,560 to Daugman entitled: “Biometric Personal Identification System Based on Iris Analysis”, in U.S. Pat. No. 8,391,566 to Cottard entitled: “Method of Identifying a Person by His Iris”, and in U.S. Pat. No. 8,588,479 to Su et al., entitled: “Biometric Authentication Apparatus, Biometric Authentication Method and Recording Medium”. Further, iris recognition technologies and applications are further described in SANS Institute document entitled: “Iris Recognition Technology for Improved Authentication” by Penny Khaw, SANS Security Essentials (GSEC) Practical Assignment Version 1.3, in Pattern Recognition Society journal: Pattern Recognition 36 (2003) 279-291 article entitled: “The Importance of Being Random: Statistical Principles of Iris Recognition” by John Daugman, and in University of Cambridge publication entitled: “How Iris Recognition Works”, by John Daugman.

Vein Matching.

Vein matching, also referred to as vascular technology, is a technique of biometric identification through the analysis of the patterns of blood vessels visible from the surface of the skin. Vascular scanners typically do not require contact with the scanner, and since the information they read is inside of the body, skin conditions do not affect the accuracy of the reading. Vascular scanners may also work with extreme speed, scanning in less than a second, where as they scan, they capture the unique pattern veins take as they branch through the hand. An example of hand vascular scanner is the Model VP-IIX available from Techsphere Co., Ltd., headquartered in Seoul, South Korea, and described in the User's Manual entitled: “VP-IIX—Hand Vascular Pattern Recognition System—User's Manual”.

Vein pattern recognition technologies and applications are described in U.S. Pat. No. 7,526,111 to Miura et al., entitled: “Personal Identification Device and Method”, and in U.S. Pat. No. 8,803,963 to Pulluru et al., entitled: “Vein Pattern Recognition Based Biometric System and Methods Thereof”. Further vein pattern recognition technologies and applications are described in an article published in the International Journal of Advance Research in Computer Science and Management Studies (IJARCSMS), Volume 2, Issue 9, September 2014 entitled: “Human Identification Based on the Pattern of Blood Vessels as Viewed on Sclera Using HOG and Interpolation Technique” by Sreelekshmi K. J. et al., in an article published in the International Journal of Control and Automation, Vol. 3, No. 1, March 2010, entitled: “Palm Vein Authentication System: A Review”, by Ishani Sarker et al., in Fujutsu Laboratories Ltd. Article entitled: “Palm Vein Authentication Technology and its Applications” by Masaki Watanabe et al., in NSTC—Subcommittee on Biometrics paper entitled: “Vascular Pattern Recognition” last updated 7 Aug. 2006, and in Fujitsu Computer Products of America, Inc. white paper WP10800306 entitled: “Palm Vein Pattern Authentication Technology”.

Finger vein recognition uses pattern-recognition techniques based on images of human palm or finger vein patterns beneath the skin's surface. Finger Vein recognition is a biometric authentication system that matches the vascular pattern in an individual finger to previously obtained data. To obtain the pattern for the database record, an individual inserts a finger into an attester terminal containing a near-infrared LED (light-emitting diode) light and a monochrome CCD (charge-coupled device) camera. The hemoglobin in the blood absorbs near-infrared LED light, which makes the vein system appear as a dark pattern of lines. The camera records the image and the raw data is digitized, certified and sent to a database of registered images. For authentication purposes, the finger is scanned as before and the data is sent to the database of registered images for comparison. The authentication process commonly takes less than two seconds. Blood vessel patterns are unique to each individual, as are other biometric data such as fingerprints or the patterns of the iris. Unlike some biometric systems, blood vessel patterns are almost impossible to counterfeit because they are located beneath the skin's surface. Biometric systems based on fingerprints can be fooled with a dummy finger fitted with a copied fingerprint; recordings and high-resolution images can fool voice and facial characteristic-based systems. The finger vein ID system is much harder to fool because it can only authenticate the finger of a living person

Eye vein verification applies pattern-recognition techniques to video images of the veins in a user's eyes. The complex and random patterns are unique, and modern hardware and software can detect and differentiate those patterns at some distance from the eyes. The veins in the sclera—the white part of the eyes—can be imaged when a person glances to either side, providing four regions of patterns: one on each side of each eye. Verification employs digital templates from these patterns, and the templates are then encoded with mathematical and statistical algorithms. The technology allows for the stability of the pattern of eye blood vessels since the patterns do not change with age, alcohol consumption, allergies, or redness. Eye veins are clear enough so that the cameras can reliably image by on most smartphones. The technology works through contacts and glasses, though may not work through sunglasses. One version of the eye-vein detection uses infrared illumination as part of the imaging, allowing imaging even in low-light conditions.

Face Recognition.

A facial recognition system is a computer application for automatically identifying or verifying a person from a digital image or a video frame from a video source, typically a digital video or stills camera. Typical facial recognition algorithms identify facial features by extracting landmarks or features, from an image of the subject face. For example, an algorithm may analyze the relative position, size, or shape of the eyes, nose, cheekbones, and jaw. These features are then used to search for other images with matching features. Other algorithms normalize a gallery of face images and then compress the face data, only saving the data in the image that is useful for face recognition. Recognition algorithms can typically be divided into two main approaches: geometric, which looks at distinguishing features, or photometric, which is a statistical approach that distills an image into values and compares the values with templates to eliminate variances. Common recognition algorithms include Principal Component Analysis using eigenfaces, Linear Discriminate Analysis, Elastic Bunch Graph Matching using the Fisherface algorithm, the Hidden Markov Model (HMM), the Multilinear Subspace Learning using tensor representation, and the neuronal motivated dynamic link matching.

Face recognition technologies and applications are described in U.S. Patent Application Publication No. 2007/0098231 to Minato entitled: “Face Identification Device”, in U.S. Pat. No. 7,203,346 to Kim et al., entitled: “Face Recognition Method and Apparatus Using Component-Based Face Descriptor”, in U.S. Pat. No. 7,953,253 to Cao et al., entitled: “Face Detection on Mobile Devices”, and in U.S. Pat. No. 8,340,366 to Masude et al., entitled: “Face Recognition System”. Further face recognition technologies and applications are described in an article published by NSTC—Subcommittee on Biometrics entitled: “Face Recognition”, last updated 7 Aug. 2006, in article in Informing Science Special Issue on Multimedia Informing Technologies—Part 2, Volume 3, No. 1, 2000, by Shang-Hung Lin entitled: “An Introduction to Face Recognition Technology”, and in an article by Xiaoguang Lu of Michigan State University entitled: “Image Analysis for Face Recognition”.

A three-dimensional (3D) face recognition technique uses 3D sensors to capture information about the shape of a face. This information is then used to identify distinctive features on the surface of a face, such as the contour of the eye sockets, nose, and chin. One advantage of 3D facial recognition is that it is not affected by changes in lighting such as other techniques, and can identify a face from a range of viewing angles, including a profile view. Three-dimensional data points from a face vastly improve the precision of facial recognition. 3D Technology is described in an article by Alexander M. Bronstein of the Technion in Israel, entitled: “Three Dimensional Face Recognition”.

Behavioral Biometrics.

Behavioral biometrics is based on a behavioral trait of an individual, such as speech patterns, signatures, hand-written, PIN, and keystrokes. A behavioral characteristic is typically a reflection of an individual psychology, and is commonly associated with fewer intrusive systems, conducing to better acceptability by the users. Behavioral biometrics is described in an article by Robert Moskovitch et al., entitled: “Identity Theft, Computers, and Behavioral Biometrics”, and in Instituto de Telecomunicacoes (of Lisboa, Portugal) publication entitled: “A Behavioral Biometric System Based on Human Computer Interaction”.

Signature/Handwritten Recognition.

Signature recognition is a behavioral biometric and can be operated in static or dynamic modes. In static mode, users write their signature on paper, digitize it through an optical scanner or a camera, and the biometric system recognizes the signature analyzing its shape. In dynamic mode, users write their signature on a digitizing tablet, which acquires the signature in real time. Another possibility is the acquisition by means of stylus-operated PDAs or smartphones. Dynamic information usually consists of spatial coordinate x(t), spatial coordinate y(t), pressure p(t), azimuth az(t), inclination in(t), and pen up/down.

Keystroke Recognition.

Keystroke dynamics, keystroke biometrics or typing dynamics, is the detailed timing information that describes exactly when each key was pressed and when it was released as a person is typing at a computer keyboard. The behavioral biometric of Keystroke Dynamics uses the manner and rhythm in which an individual types characters on a keyboard or keypad. The keystroke rhythms of a user are measured to develop a unique biometric template of the user's typing pattern for future authentication.

Voice/Speaker Recognition.

Speaker recognition is the identification of the person who is speaking by characteristics of their voices (voice biometrics), also called voice recognition. Speaker recognition uses the acoustic features of speech that were found to differ between individuals. These acoustic patterns reflect both anatomy (e.g., size and shape of the throat and mouth) and learned behavioral patterns (e.g., voice pitch, speaking style). The various technologies used to process and store voice prints include frequency estimation, hidden Markov models, Gaussian mixture models, pattern matching algorithms, neural networks, matrix representation, Vector Quantization and decision trees.

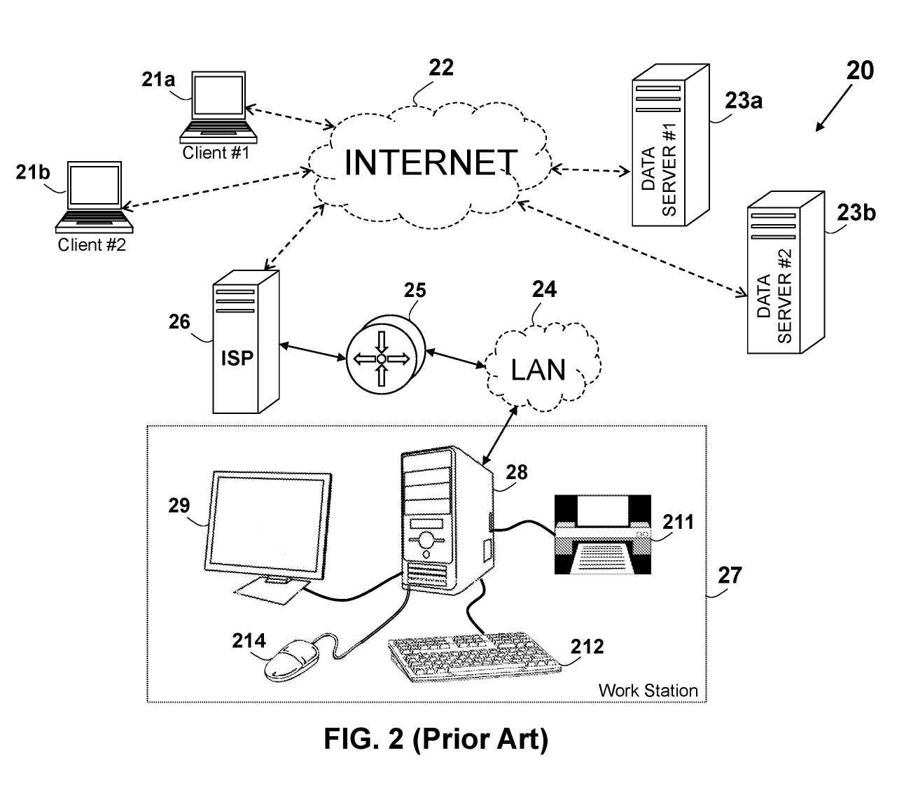

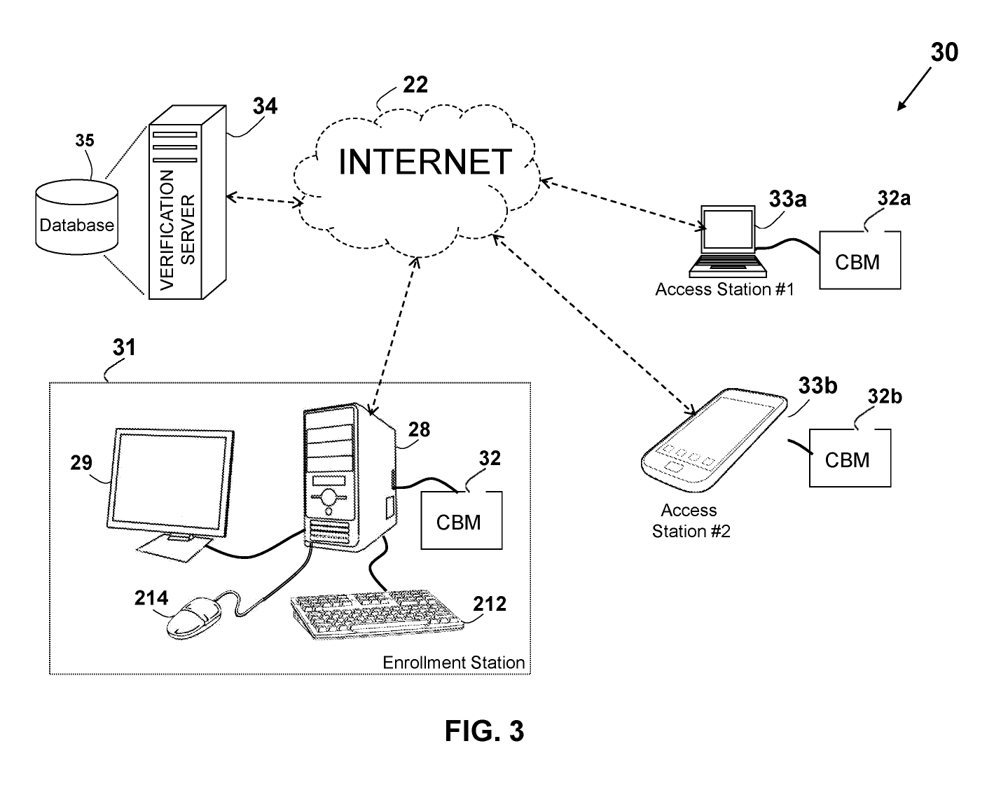

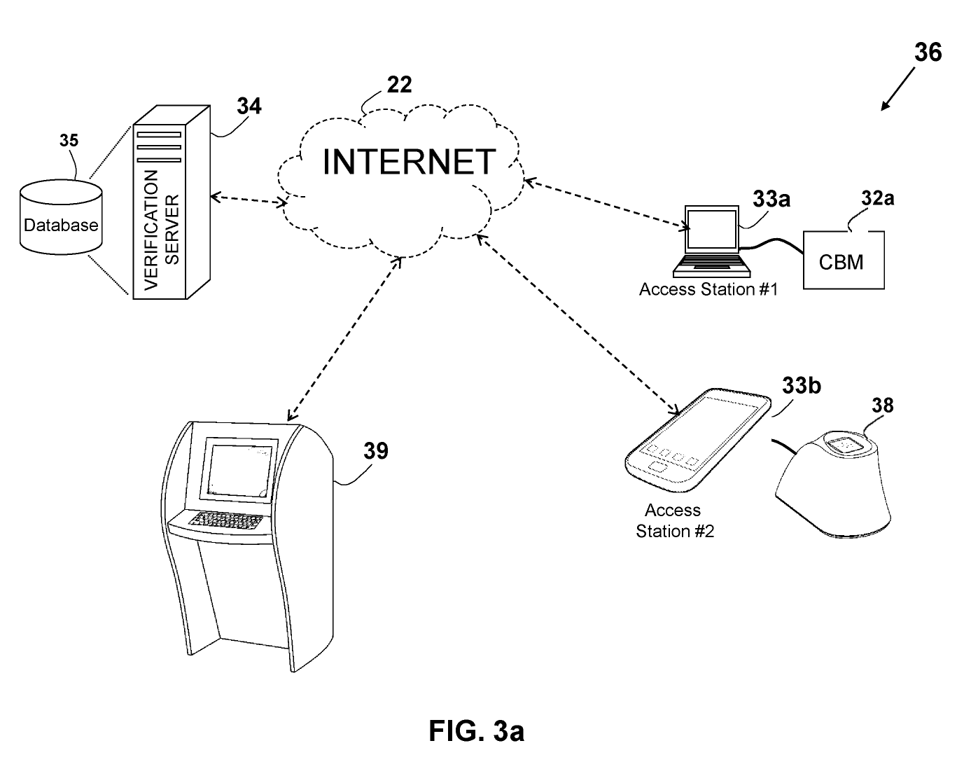

An arrangement 30 for creating, updating, and using, the memory 35 storing table 40, is shown in FIG. 3. A database including the table 40 is stored in a memory 35 that is connected to, or part of, a server 34 connected to the Internet 22. The table 40 is created and updated using an enrollment station 31 connected to the Internet 22. The enrollment station 31 may be based on, may include, or may consist of, the work station 27 shown in FIG. 2, further including a Biometrics Capturing Module (BCM) 32, connected to, or part of, the computer 28.

The BCM 32 is a biometric sensor serving as an input device to capture an individual biometrics. The BCM 32 may be a device for capturing the physiological characteristics of an individual, such as a fingerprints reader (a.k.a. fingerprints scanner) for capturing an individual fingerprints, an iris scanner or camera for capturing an individual Iris image (using Near Infrared (NIR) wavelength band or Visible Wavelength (VW) band), a hand geometry reader, for capturing an hand geometry pattern or image, a vascular scanner or camera for sensing a vein pattern or image of a palm, finger, or eye, or a digital camera for capturing a face pattern or image. Similarly, the BCM 32 may be a biometric sensor serving as an input device to capture behavioral characteristics, such as Personal Identification Number (PIN), signature or handwritten recognition, keystroke recognition, or voice/speech recognition, and may consists of a keyboard, microphone, camera, or a pressure-sensitive plate.

The table 40 stored in the memory 33 may be used for access control for an individual using a computer, and a CBM adapted to capture a person biometric that is stored in the table 40. The CBM used for verification may be the same, similar, based on, or of the same type as the CBM 32 being part of the enrollment station 31. For example, the CBM 32 may be a fingerprints reader that captures a person fingerprint that are later stored in table 40 as part of a fingerprint file vas described for the column 41b, the CBM used for authentication, verification, or access control, is preferably also a fingerprint reader. In one example, an access station may include a laptop computer 33a, integrated with, including, or connected to a CBM 32a. Similarly, an access station may use a smartphone 33b, integrated with, including, or connected to, a CBM 32b. While a single enrollment station 31 is shown, it is apparent that multiple enrollment stations may equally be applied. Similarly, while two access stations 33a and 33b are shown, it is apparent that a single, three, or more access stations may equally be applied.

A pictorial view 36 of arrangement 30 is shown in FIG. 3a, wherein the enrollment station 31 is implemented as a kiosk 39, and the CBM 32b is implemented as a fingerprints reader 38.

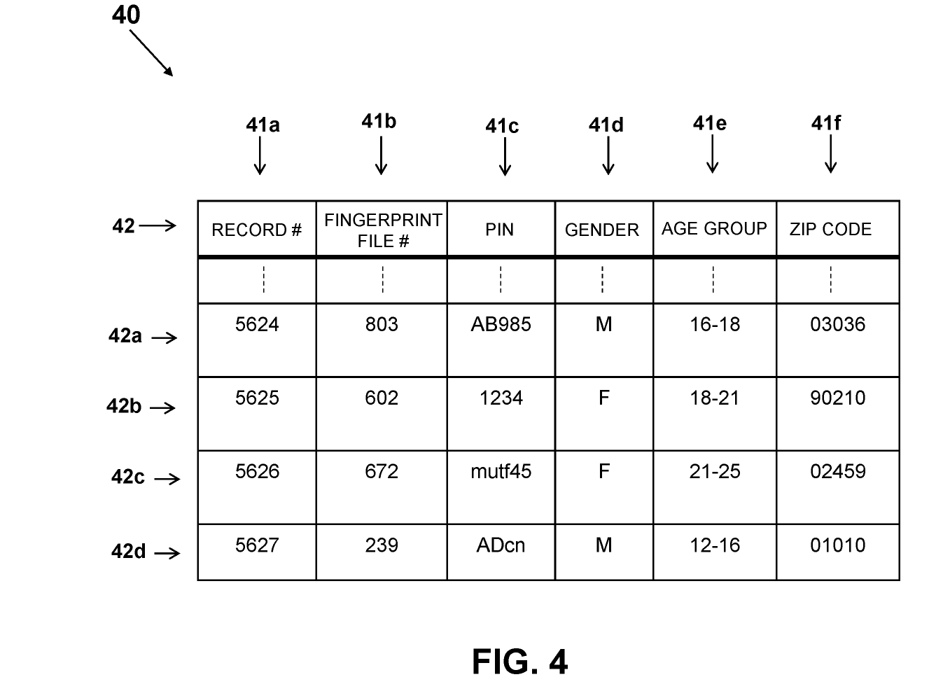

An exemplary biometric data may be arranged as the table 40 shown in FIG. 4 that may represents an anonymous biometric database stored in the memory 33. Each row in the anonymous database 40 represent a record containing information data relating to a single person. The content of the table 40 may be organized by columns as represented in the table 40, where the column headings are shown in a row 42. A first column 41a is designated as “RECORD #” column, serves to identify the record number, corresponding to an individual number identification in the database. A second column 41b designated as “FINGERPRINT FILE #” serves as an identifier (such as an address or any other storage location identification) for a formerly captured biometric identifying data if the individual associated with the record of the associated row. A third column 41c designated as “PIN” includes the PIN associated with the individual identified by a specific record. A fourth column 41d designated as “GENDER” includes the associated individual gender, either “M” for male or “F” for female. A fifth column 41e designated as “AGE GROUP” is associated the individual age, identified by a selected age group. For example, a set of few age groups may be defined, such as a first age group 0-12 referring to children below the age of 12, as well as other age groups such as 12-16, 16-18, 18-21, 21-25, 25-35, and so forth. A sixth column 41f designated as “ZIP” includes the associated individual residence address, such as the address ZIP code. Each record (shown as a row in table 40) may further includes information about the record creation, such as when the record was created or updated, and how and by whom (such as from which enrollment station).

In the example of table 40 shown in FIG. 4, an individual identified with the first row 42a is associated with record number 5624, his captured fingerprint data can be accessed using the identifier 803 (e.g., an image file named 803.img), the associated PIN is ‘AB985’, and the individual is a male of 16-18 age, living in ZIP code 03036. Similarly, an individual identified with the second row 42b is associated with record number 5625, his captured fingerprint data can be accessed using the identifier 602 (e.g., an image file named 602.gif), the associated PIN is ‘1234’, and the individual is a female of 18-21 age, living in ZIP code 90210. Similarly, an individual identified with a third row 42c is associated with record number 5626, his captured fingerprint data can be accessed using the identifier 672 (e.g., an image file named 672.tiff), the associated PIN is ‘muft45’, and the individual is a female of 21-25 age, living in ZIP code 02459. Similarly, an individual identified with a fourth row 42d is associated with record number 5627, his captured fingerprint data can be accessed using the identifier 239 (e.g., an image file named 239.png), the associated PIN is ‘ADcn’, and the individual is a male child of 12-16 age, living in ZIP code 01010.

In one example, a single record, or each of the stored records stored in table 40, contains PII data that can be used on its own or with other information in the record to identify, contact, or locate a single person, or to identify an individual in context. However, preferably a single record or all the stored records in the database 35 (serving as anonymous biometric database) do not contain any PII data (alone or combined with other data in the record), and thus only identify a group of individuals, obviating the capability to identify, contact, or locate a single person, or to identify an individual in context. In the example that is shown in FIG. 4, fingerprint data cannot identify an individual per se, and may only be used as a reference for comparison to another fingerprint data. Similarly, the information stored in each record may be associated with a large number of individuals. For example in record #5625 (row 42b), it is expected that at least few hundreds of women in the age group of 18-21 live in ZIP code 90210 in the U.S. With the exception of the biometric related data such as the fingerprint file in column #41c, a single record in table 40 (or all the records) may be associated with a group of 10, 20, 50, 100, 200, 500, 1,000, 5,000, 10,000 people or more. The existence of many people in such a group suggests higher degree of anonymity and provide protection against impersonation attacks. As such, information privacy or data protection laws may not apply to creating, storing, or using such a database, and may further allow easy and non-risky usage by individuals. Further, information stolen from the table 40 cannot be misused to construct artificial biometrics to impersonate people.

While the traits exampled in the table 40 include gender, age, and zip code, it is apparent that any other traits, alone or in combination, may be used, including any anthropometry traits. One or more of the traits may be traits that are discrete in nature, typically selected from a limited group, such as gender (selected out of a group involving male and female), race, ethnicity, skin color, hair color, or eye color. Similarly, one or more traits may be of a numerical value that is a continuous variable, such as age, weight, or height. In the latter case, the value associated with the individual may be the measured value, or part of a range, such as the age group exampled in the table 40. While the age trait is described in the table 40 as an age group, it may be represented by a date of birth, week of birth, month of birth, or year of birth. As used herein, the address of individual (either actual address or residence) is also considered as an individual personal trait, and may be in the form of a street name, city name, ZIP code (as is exampled in the table 40), state, or country.

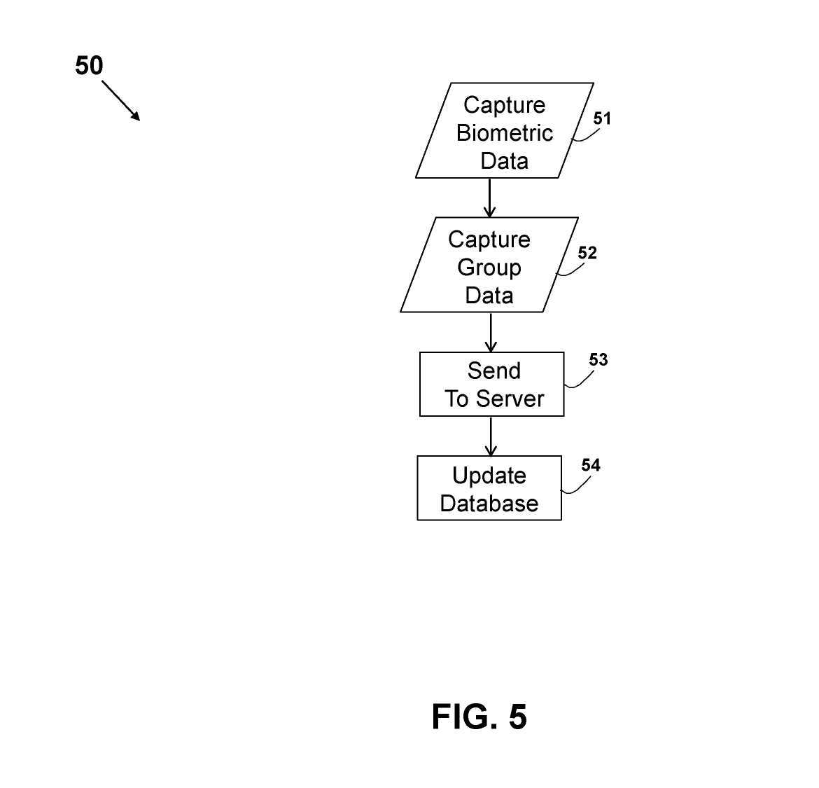

The creating and updating of the table 40 for an enrolling individual is described in a flow chart 50 shown in FIG. 5, typically executed by the computer 28 in the enrollment station 31 and the server 34. At a “Capture Biometric Data” step 51 the CBM 32 is used to capture an individual biometric data of the enrolling individual. For example, in the case of using fingerprints, the CBM 32 used as part of the enrollment station 31 is a fingerprint reader or scanner, and the biometric data stored as part of the database 35 is a fingerprint file as described regarding the column 41b of the table 40. In addition to the captured biometric data, additional personal data related to the enrolling individual is received and captured as part of a “Capture Group Data” step 52. While the enrolled individual PII may be captured, preferably only non-PII data is received and captured. In the example of the table 40 shown in FIG. 4, such non-PII data includes the enrolled individual gender, age group, ZIP code, as well as a PIN. The non-biometrics related data may be input to the enrollment station 31 using the keyboard 212, the pointing device (computer mouse) 214, or any other textual or graphical means for entering information to a computer.

The enrolling individual captured data, including the captured biometric data and the ‘Group’ or PII data, are sent via the Internet 22 to the server 34, as part of a “Send to Server” step, and are stored as part of the table 40 stored in the memory 35 as part of an “Update Database” step 54. In the case where the enrolling individual is new to the system, a record is added that is associated with this enrolling individual, and a unique record number (as shown in the Column 41a) is assigned to the newly created record, allowing for future reference to the enrolling individual record. Alternatively or in addition, a former record of the individual may be updated.

In order to allow for credible and reliable information, it is preferred that the process of updating or creating a record for an enrolling individual is made under credible and reliable conditions, such as by a trustworthy person that is authorized and trained to operate the enrollment station, and that uses credible evidences for identifying the enrolling individual, such as using a government-issued ID for verifying the ZIP code of the residence and the person age. Alternatively or in addition, the operator may personally verify characteristics such as gender, height, age or other attributes that may be externally and specifically visualized or estimated.

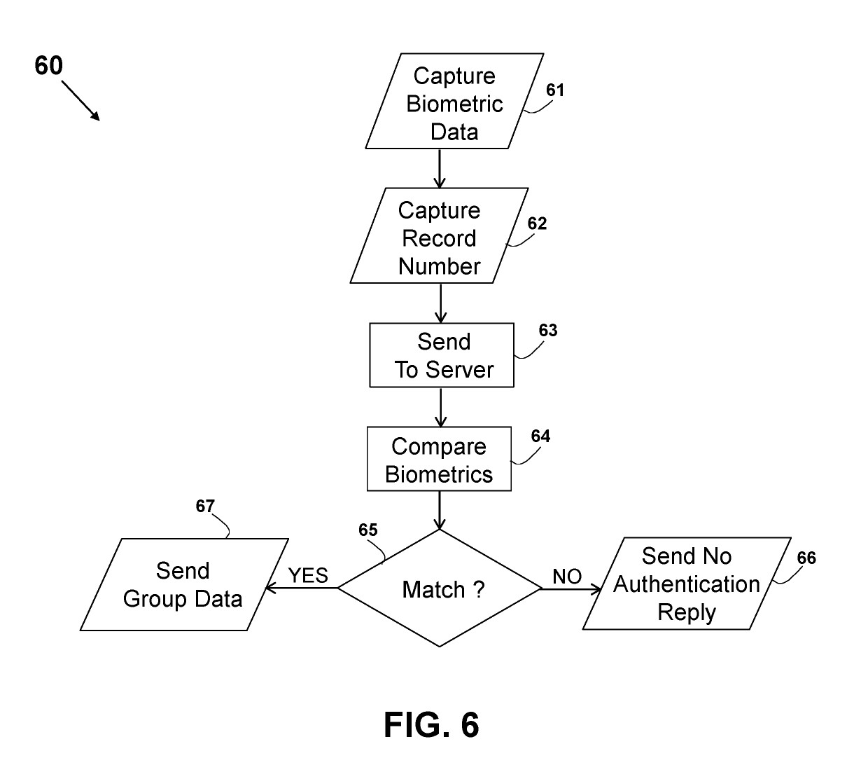

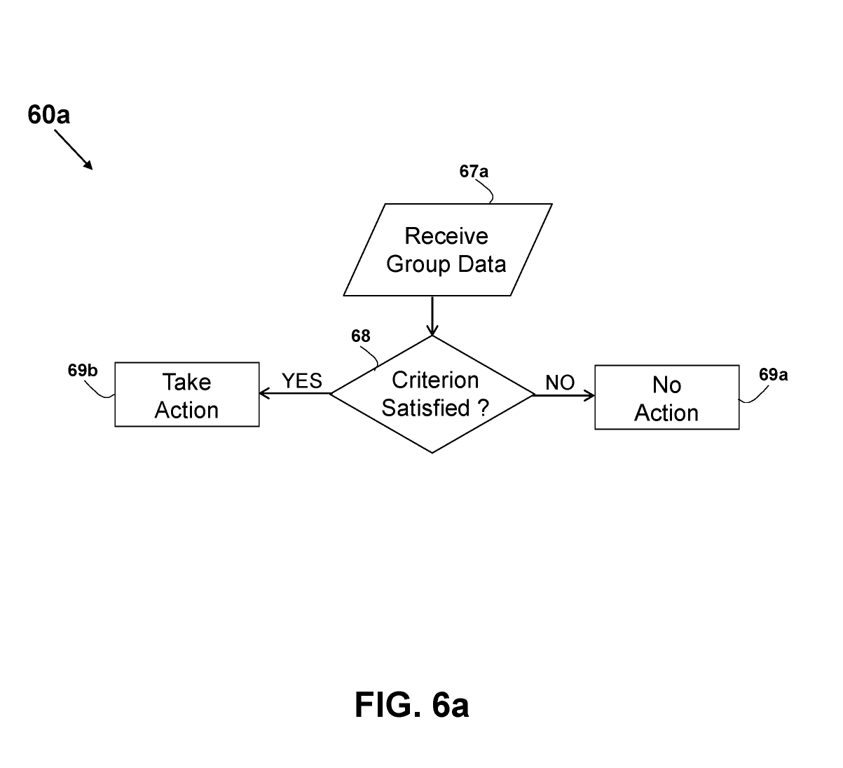

The using of the table 40 for verification or access control of an accessing individual is described in a flow chart 60 shown in FIG. 6, typically executed by an access station computer, such as the laptop 33a. At a “Capture Biometric Data” step 61, a CBM such as the CBM 32a (connected to or part of the laptop 33a) is used to capture the accessing individual biometric data. For example, in the case of using fingerprints, the CBM 32a as part of the access station is a fingerprint reader or scanner. At a “Capture Record Number” step 62, the record number that was assigned to the accessing individual as part of the enrollment process as part of the “Update Database” step 54 is input to the access station. The captured biometric data and the record number associated with the accessing individual are sent to the server 34 as part of a “Send to Server” step 63. In a “Compare Biometrics” step 64 the server 34 compares the received captured biometrics data of the accessing individual to the stored biometrics data relating to the record number stored in table 40 in the memory 35. For example, if the biometrics data includes fingerprints image, the fingerprint file is fetched from memory 35 by using the file identifying data stored at part of the enrollment process by the column 41b in the table 40, and compared to the fingerprints image received from the accessing individual via the access station. The images are compared for matching in a “Match ?” step 65. In the case no match is found, it is assumed that the accessing individual is not the same person as the person associated with the record number provided, and thus an appropriate message is sent over the Internet 22 to the access station as part of a “Send No Authentication Reply” step 66. In the case a match is found, it is assumed that the accessing individual is the same person as the person associated with the record number provided, and thus an appropriate message is sent over the Internet 22 to the requesting access station. For example, such message may include one or more information included in the respective record, as part of a “Send Group Data” step 67. In the example of table 40 and assuming record number 5627, the message may include the accessing individual gender as male (‘M’ in the gender column 41d), the age group as 12-16 (′12-16′ in the age group column 41e), the ZIP code as 01010 (‘01010’ in the ZIP column 41f), or any combination thereof.

In the case a match is found in the “Match ?” step 65 in the flow chart 60, the individual is considered identified, and access to the non-biometric part of the record is provided, and may be used as described in a flow chart 60a shown in FIG. 6a. The non-biometric part of the record is sent to the access station (such as the access station 33a or 33b) as part of the “Send Group Data” step 67, to be received by the requesting access station as part of a “Receive Group Data” step 67a. The non-biometric personal traits may be used for controlling an action. In such a scheme, one or more of the traits are compared against a current or pre-set criterion, as part of a “Criterion Satisfied ?” step 68. In a case where the criterion is met, then the action is allowed to be taken as part of a “Take Action” step 69b. In a case where the criterion is not satisfied, the action is not allowed, as noted by a “No Action” step 69a. For example, an action is to be taken if the individual is a female, and in such a case, only the individuals associated with records 5625 42b and 5626 42c may initiate the action. Similarly, in the case the criterion is that only individuals of age above 21 years may trigger the action, only the individual associated with record 5626 42c may initiate the action. Similarly, the criterion may involve only individuals residing in a geographical location may allow the action to be taken. Similarly, multiple criteria may be equally applied. For example, in the case the criterions are satisfied only by males above 16, only the individual associated with record 5624 42a satisfies the criteria. The action may involve access to a resource. In the case of discrete traits, the criterion may relate to one or more features of the options. In the example of hair color, one or multiple specified colors may satisfy the criterion. In the case of continuous numerical range, the criterion may relate to a maximum or minimum threshold. For example, only individuals above a specific height or below a specific weight.

In one example, the criterion (or criterions) that is used is sent to the verification server 34, and the checking of satisfying the criterion is performed at the server 34, which executes the “Criterion Satisfied ?” step 68. In such a scenario, the result or the criterion checking, namely the “No Action” step 69a or the “Take Action” step 69b, is sent to the requesting access station to be executed. In such a case, higher privacy may be obtained, since the access station is unaware of the actual database content, but rather whether the criterion is met or not. The actions may be initiated/allowed or prohibited based on gender, age, geographical location (e.g., residence address), or any other personal traits.

Access control is the selective restriction of access to a place or other resource. The systems and methods described herein may be used for access control, where the action (e.g., in the “Take Action” step 69b) involves permission to access a resource, referred to as authorization, and the act of accessing may involve consuming, entering, or using.

Physical access control refers to the practice of restricting entrance to a property, a building, or a room to authorized persons. Physical access control may be achieved by a human (a guard, bouncer, or receptionist) through mechanical means such as locks and keys, or through technological means such as access control systems like the mantrap. Within these environments, physical key management may also be employed as a means of further managing and monitoring access to mechanically keyed areas or access to certain small assets. An access control system determines who is allowed to enter or exit, where they are allowed to exit or enter, and when they are allowed to enter or exit. Electronic access control uses computers to solve the limitations of mechanical locks and keys. A wide range of credentials can be used to replace mechanical keys. The electronic access control system grants access based on the presented credential. When access is granted, the door is unlocked for a predetermined time, and the transaction is recorded. When access is refused, the door remains locked and the attempted access is recorded. The system will also monitor the door and alarm if the door is forced open or held open too long after being unlocked.

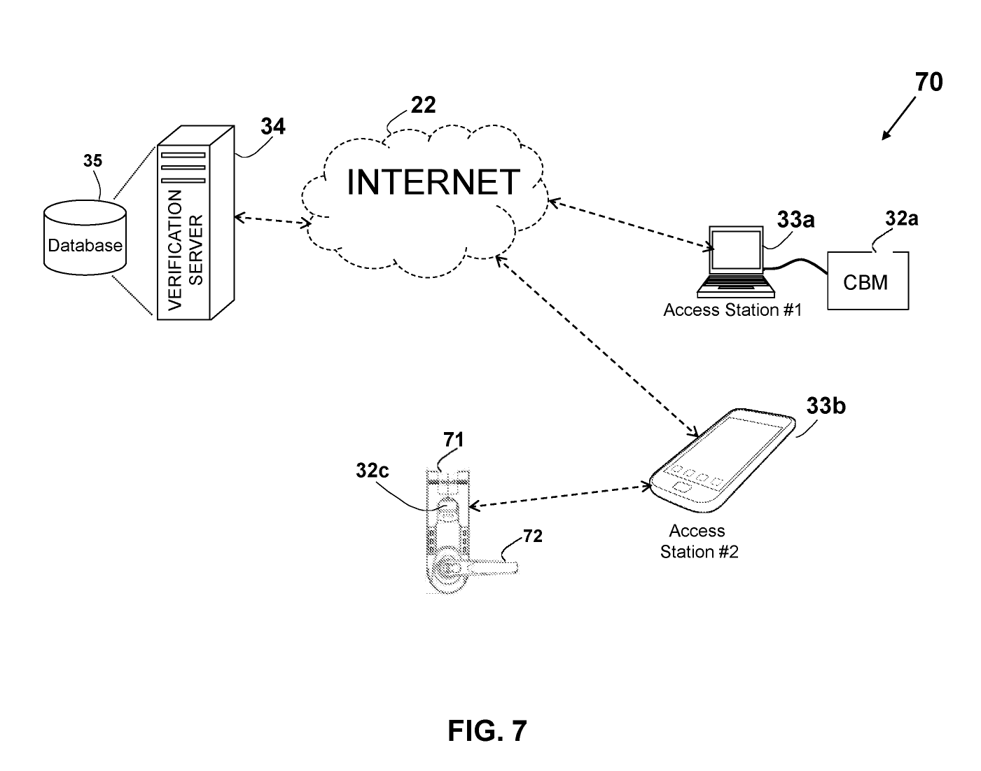

In one example shown as an arrangement 70 in FIG. 7, the system is used for a room physical access control. A door lock mechanism 71 includes a handle 72 for opening the door to the room, and a fingerprint reader 32c (corresponding to CBM 32b). Upon satisfying the pre-set criterion, the corresponding action may be activating the door lock mechanism 71 and allowing access to the room. The door lock mechanism 71 may be integrated, or be communicating, with the access station #2 33b.

In one example, the action to be taken in the “Take Action” step 69b is displaying to a person other than the individual the trait value of the individual, or displaying whether the criterion is met or not, as part of the step “No Action” 69a. Further, the notification that no record was found in the database that is associated with the individual. For example, in some countries it is illegal to sell alcohol to minors (such as below 18). An alcohol seller may use the system to check whether a potential buyer is a minor or adult.

A web browser (commonly referred to as a browser) is a software application for retrieving, presenting, and traversing information resources on the World Wide Web. An information resource is identified by a Uniform Resource Identifier (URI/URL) and may be part of a web page, a web-page, an image, a video, or any other piece of content. Hyperlinks present in resources enable users easily to navigate their browsers to related resources. Although browsers are primarily intended to use the World Wide Web, they can also be used to access information provided by web servers in private networks or files in file systems. The primary purpose of a web browser is to bring information resources to the user (“retrieval” or “fetching”), allowing them to view the information (“display”, “rendering”), and then access other information (“navigation”, “following links”). Currently, the major web browsers are known as Firefox, Internet Explorer, Google Chrome, Opera, and Safari.

The process begins when the user inputs a Uniform Resource Locator (URL), for example ‘en.wikipedia.org’, into the browser. The prefix of the URL, the Uniform Resource Identifier or URI, determines how the URL is interpreted. The most commonly used kind of URI starts with http: and identifies a resource to be retrieved over the Hypertext Transfer Protocol (HTTP). Many browsers also support a variety of other prefixes, such as https: for HTTPS, ftp: for the File Transfer Protocol, and file: for local files. Prefixes that the web browser cannot directly handle are often handed off to another application entirely. For example, mailto: URIs are usually passed to the user's default e-mail application, and news: URIs are passed to the user's default newsgroup reader. In the case of http, https, file, and others, once the resource has been retrieved the web browser displays it. HTML and associated content (image files, formatting information such as CSS, etc.) is passed to the browser's layout engine, to be transformed from markup to an interactive document, a process known as “rendering”. Aside from HTML, web browsers can typically display any type of content that can be part of a web page. Most browsers can display images, audio, video, and XML files, and often have plug-ins to support Flash applications and Java applets. Upon encountering a file of an unsupported type or a file that is set up to be downloaded rather than displayed, the browser prompts the user to save the file to disk. Information resources may contain hyperlinks to other information resources. Each link contains the URI of a resource to be used. When a link is clicked, the browser navigates to the resource indicated by the link's target URI, and the process of bringing content to the user begins again. The architecture of a web browser is described in a publication entitled: “Architecture and evolution of the modern web browser” by Alan Grosskurth and Michael W. Godfrey of the University of Waterloo in Canada, dated Jun. 20, 2006.

A currently popular web browser is the Internet Explorer (formerly Microsoft Internet Explorer and Windows Internet Explorer, commonly abbreviated IE or MSIE) from Microsoft Corporation, headquartered in Redmond, Wash., U.S.A., which is a series of graphical web browsers developed by Microsoft and included as part of the Microsoft Windows line of operating systems. The Internet Explorer 8 is described, for example, in Microsoft 2009 publication entitled: “Step by Step Tutorials for Microsoft Internet Explorer 8 Accessibility Options”. Another popular web browser is the Google Chrome, which is a freeware web browser developed by Google, headquartered in Googleplex, Mountain View, Calif., U.S.A. Google Chrome aims to be secure, fast, simple, and stable, providing strong application performance and JavaScript processing speed.

A mobile browser, also called a microbrowser, minibrowser, or Wireless Internet Browser (WIB), is a web browser designed for use on a mobile device such as a mobile phone or PDA. Mobile browsers are optimized to display Web content most effectively for small screens on portable devices. Mobile browser software must be small and efficient to accommodate the low memory capacity and low-bandwidth of wireless handheld devices. Some mobile browsers can handle more recent technologies like CSS 2.1, JavaScript, and Ajax. Websites designed for access from these browsers are referred to as wireless portals or collectively as the Mobile Web. They may automatically create “mobile” versions of each page.

A mobile browser typically connects via a cellular network, via a Wireless LAN, or via other wireless networks, and is using standard HTTP over TCP/IP, and displays web pages written in HTML, XHTML Mobile Profile (WAP 2.0), or WML (which evolved from HDML). WML and HDML are stripped-down formats suitable for transmission across limited bandwidth, and wireless data connection called WAP. WAP 2.0 specifies XHTML Mobile Profile plus WAP CSS, subsets of the W3C's standard XHTML and CSS with minor mobile extensions. Some mobile browsers are full-featured Web browsers capable of HTML, CSS, ECMAScript, as well as mobile technologies such as WML, i-mode HTML, or cHTML. To accommodate small screens, some mobile browsers use Post-WIMP interfaces. An example of a mobile browser is Safari, which is a mobile web browser developed by Apple Inc. (headquartered in Apple Campus, Cupertino, Calif., U.S.A), included with the OS X and iOS operating systems, and described in Apple publication entitled: “Safari Web Content Guide”, dated March 2014.

Online chat refers to any kind of communication over the Internet that offers a real-time transmission of text messages (which may be supplemented with images or video data) from sender to receiver. Typically, chat messages are commonly short in order to enable other participants to respond quickly, thereby creating a feeling similar to a spoken conversation. Online chat may address point-to-point communications as well as multicast communications from one sender to many receivers and voice and video chat, or may be a feature of a web conferencing service. The term chat room or chatroom, is primarily used to describe any form of synchronous conferencing, occasionally even asynchronous conferencing. The term can thus mean any technology ranging from real-time online chat and online interaction with strangers instant messaging and online forums to fully immersive graphical social environments. The primary use of a chat room is to share information via text with a group of other users, providing the ability to converse with multiple people in the same conversation using. The users in a particular chat room are generally connected via a shared interest or other similar connection, and chat rooms exist catering for a wide range of subjects. Some chat rooms support the use of file sharing and webcams.

An Internet forum, or a message board, is an online discussion site where people can hold conversations in the form of posted messages, and is different from chat rooms in that messages are often longer than one or few lines of text, and are at least temporarily archived. In addition, depending on the access level of a user or the forum set-up, a posted message might need to be approved by a moderator before it becomes visible. A discussion forum is typically hierarchical or tree-like in structure: a forum can contain a number of sub-forums, each of which may have several topics. Within a forum topic, each new discussion started is called a thread, and can be replied to by as many people as so wish. Depending on the forum's settings, users can be anonymous or have to register with the forum and then subsequently log-in in order to post messages.

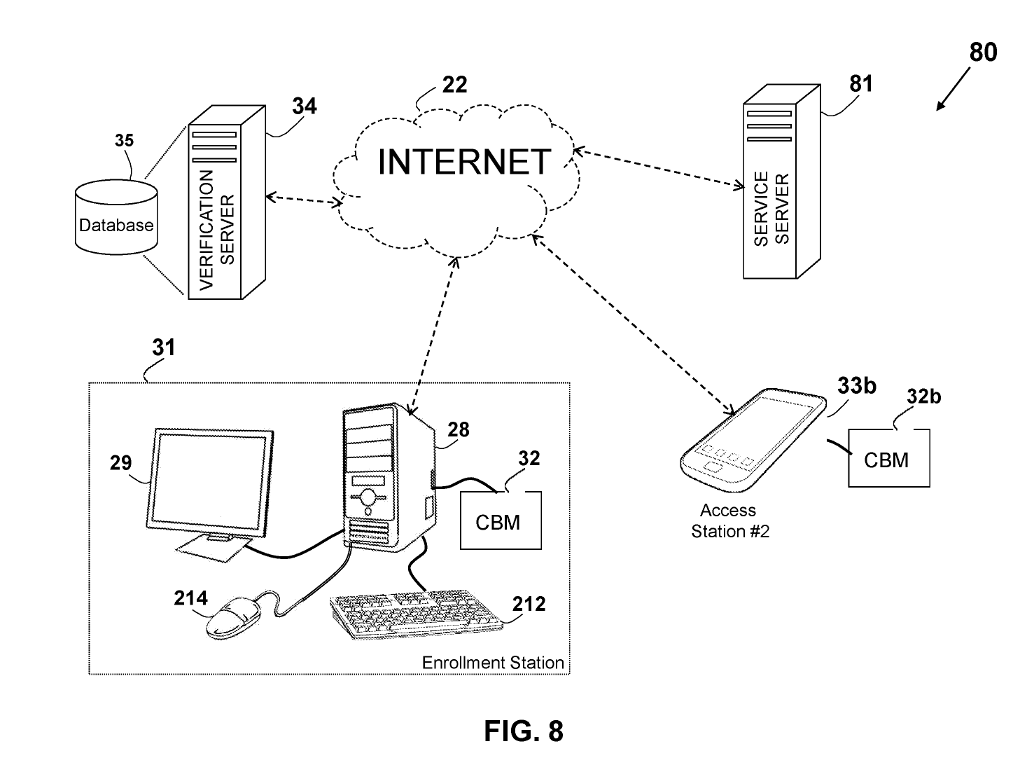

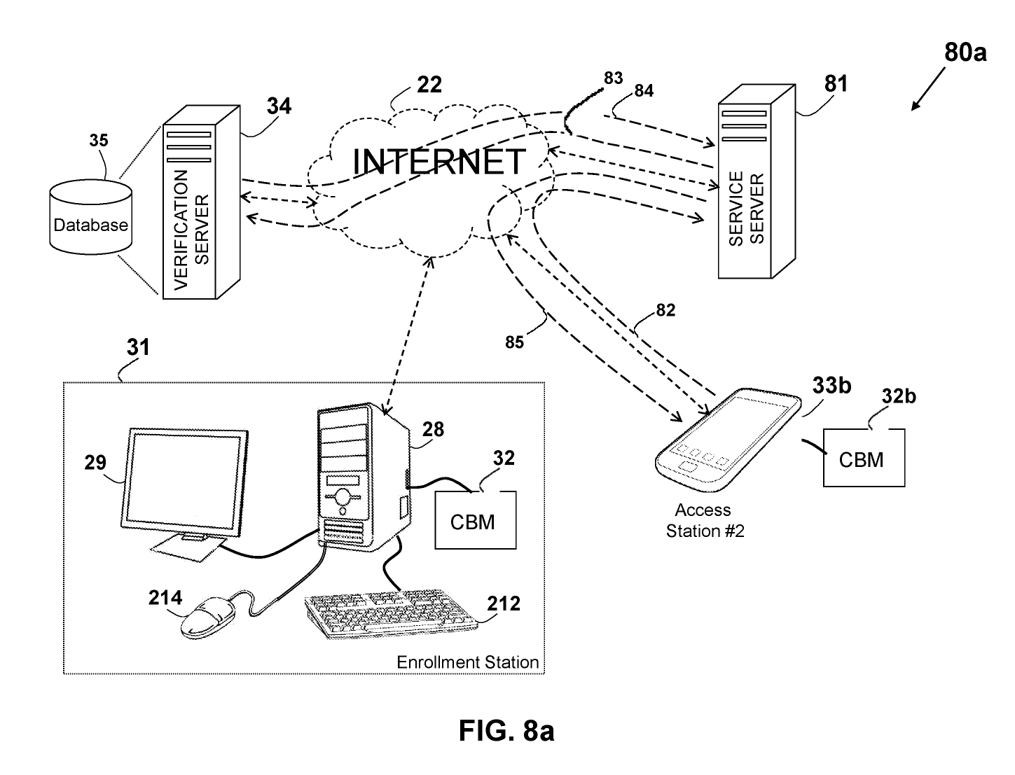

While the CBM and the access station were exampled as being integrated or co-located, they may equally be separate and remote from each other, communicating over a digital network. In the example shown as the arrangement 70 in FIG. 7, both the biometric sensor, such as the fingerprints reader 32c, and the controlled action (opening the door via the lock mechanism 71 or handle 72) are integrated or co-located, they may equally be separate and remote from each other. In one example, the system may be used to allowing access to resources remote from the access station. Such an arrangement 80 is shown in FIG. 8, including a remote service server 81. The service server 81 may store, or control access to, a resource. The resource may be a content stored in, or connected to, the service server 81. Alternatively or in addition, the resource may be a service provided or controlled by the service server 81, such as a chat room or Internet forum. Further, the service server 81, may provide resources such as HTML files and other content, or performs other functions on behalf of the service provider or a client, typically by returning a response message to the client.

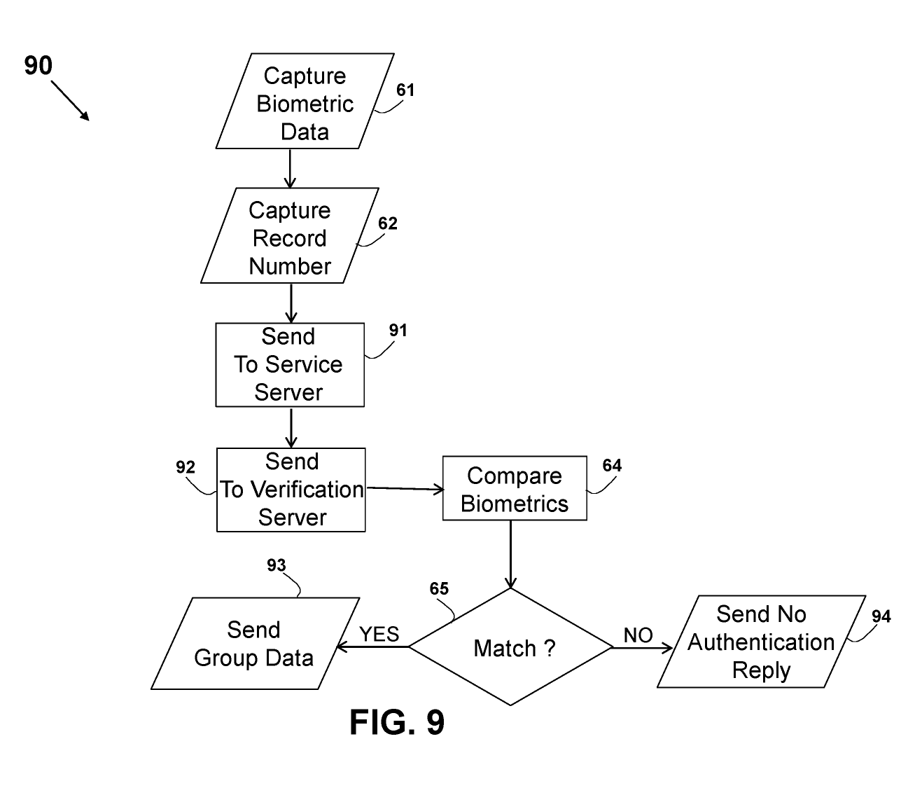

A flow chart 90 shown in FIG. 9 describes the system operation involving the arrangement 80 shown in FIG. 8, and arrangement 80a shown in FIG. 8a depicts a corresponding messaging flow in the system. Similar to flow chart 60 shown in FIG. 6, an individual biometric data is captured as part of the “Capture Biometric Data” step 61 using a CBM (such as the CBM 32b), together with receiving the associated individual record number as part of the “Capture Record Number” 62, using the access station, such as the access station #2 33b. The captured biometric data and the respective record number are sent to the service server 81 as part of a “Send to Service Server” step 91, schematically shown as a dashed line 82 in illustration 80a in FIG. 8a. Typically, message includes the captured biometric data and the respective record number, combined with a request for the resource (content or service) associated with the service server 81. For example, the request may consists of a request to join, register, or participate in an on-line chat room or an Internet forum provided by the service server 81.

The service server 81 then sends the received captured biometric data and the respective record number to the verification server 34 for authentication, as part of a “Send to Verification Server” step 92, schematically shown as a dashed line 83 in the illustration 80a in FIG. 8a. The captured biometric data is compared to the stored biometric data template associated with the record number in the database, as part of the “Compare Biometric” step 64. A match is validated as part of the “Match ?” step 65, and the matching response is sent to the requesting service server 81, schematically shown as a dashed line 84 in illustration 80a in FIG. 8a. If no match is found, the requesting service server 81 is accordingly notified as part of a “Send No Authentication Reply” step 94. In the case a match is found, one or more of the traits values are sent to the requesting server 81 as part of a “Send Group Data” step 93. Alternatively or in addition, the authentication request sent by the service server 81 to the verification server 34 may include one or more criterions, and the verification server response includes indication whether the criterions are satisfied, as described in flow chart 60a above. In the case the criterions are met, the user via the access station (such as the access station #2 33b) may access the resource (such as content or service) provided by the service server 81, schematically shown as a dashed line 85 in illustration 80a in FIG. 8a. For example, in the case where the Internet form on chat room is intended for use for adults only, access will be provided only to individuals having a proper age, such as above 18. Similarly, child-related forms or chat rooms will be blocked to adults identified as having an age above 18, disabling adults impersonating as minors. Similarly, men may not be admitted to women-only chat rooms or Internet forums.

The arrangements, systems, and methods, are exampled above as using fingerprint for biometric recognition. Alternatively or in addition, any type of biometric may equally be used.

Multimodal.

The arrangements, systems, and methods, are described above as using a unimodal biometric approach, utilizing a single characteristic (such as the fingerprint described in relation with the column 41b in table 40 shown in FIG. 4), as well as using a single CBM 32 in the enrollment process, and a single CBM (such as the CBM 32a) in the access station (such as the access station 33a). Alternatively or in addition, a multimodal biometric approach may be equally used, where more than one physiological or behavioral characteristic is used for enrollment, verification, or identification. For example, two physiological or behavioral characteristics may be used for enrollment, verification, or identification. In such a case, an additional column may be added to table 40 shown in FIG. 4. For example, hand geometry samples may be added to the fingerprint samples, and a hand geometry sensor may be added to both the enrollment station 31 and to each of the access stations 33a and 33b. In such a scenario, both fingerprints and hand geometry biometrics data are captured in the “Capture Biometric Data” step 51, sent to the server 34 as part of “Send to Server” step 53, and stored as part of each record in the table as part of the “Update Database” step 54. Similarly, both captured biometrics data are compared to the respective stored samples in the “Compare Biometrics” step 64, and matching is decided in the “Match ?” step 65 based on both comparing results.

While the verification server 34 is shown to be located at a location distinct from the access station or enrollment station 31 location, it is equally applicable that the server 34 (and the database 35) may be located anywhere, including in the same room, building, or neighborhood. Further, while the communication between the server 34 and the enrollment station 31, as well as the communication with the access stations 33a and 33b, is using the Internet 22, any type of digital network may be used, such as WAN, LAN, or PAN.

Each of the devices denoted herein as servers, such as the server 34, may typically function as a server in the meaning of client/server architecture, providing services, functionalities, and resources, to other devices (clients), commonly in response to the clients' request. Each of the server devices may further employ, store, integrate, or operate a server-oriented operating system, such as the Microsoft Windows Server® (2003 R2, 2008, 2008 R2, 2012, or 2012 R2 variant), Linux™ (or GNU/Linux) variants (such as Debian based: Debian GNU/Linux, Debian GNU/kFreeBSD, or Debian GNU/Hurd, Fedora™, Gentoo™, Linspire™, Mandriva, Red Hat® Linux available from Red Hat, Inc. headquartered in Raleigh, N.C., U.S.A., Slackware®, SuSE, or Ubuntu®), or UNIX®, including commercial UNIX® variants such as Solaris™ (available from Oracle Corporation headquartered in Redwood City, Calif., U.S.A.), AIX® (available from IBM Corporation headquartered in Armonk, N.Y., U.S.A.), or Mac™ OS X (available from Apple Inc. headquartered in Cupertino, Calif., U.S.A.), or free variants such as FreeBSD®, OpenBSD, and NetBSD®. Alternatively or in addition, each of the devices denoted herein as servers, may equally function as a client with the meaning of client/server architecture.

Devices that are not denoted herein as servers, such as client devices (such as the access station #1 33a, the access station #2 33b, or the enrollment station computer 28) may typically function as a client with the meaning of client/server architecture, commonly initiating requests for receiving services, functionalities, and resources, from other devices (servers or clients). Each of the these devices may further employ, store, integrate, or operate a client-oriented (or end-point dedicated) operating system, such as Microsoft Windows® (including the variants: Windows 7, Windows XP, Windows 8, and Windows 8.1, available from Microsoft Corporation, headquartered in Redmond, Wash., U.S.A.), Linux, and Google Chrome OS available from Google Inc. headquartered in Mountain View, Calif., U.S.A. Further, each of the these devices may further employ, store, integrate, or operate a mobile operating system such as Android (available from Google Inc. and includes variants such as version 2.2 (Froyo), version 2.3 (Gingerbread), version 4.0 (Ice Cream Sandwich), Version 4.2 (Jelly Bean), and version 4.4 (KitKat)), iOS (available from Apple Inc., and includes variants such as versions 3-7), Windows® Phone (available from Microsoft Corporation and includes variants such as version 7, version 8, or version 9), or Blackberry® operating system (available from BlackBerry Ltd., headquartered in Waterloo, Ontario, Canada). Alternatively or in addition, each of the devices that are not denoted herein as servers may equally function as a server in the meaning of client/server architecture. Any one of the servers herein may be a web server using Hyper Text Transfer Protocol (HTTP) that responds to HTTP requests via the Internet, and any request herein may be an HTTP request.

Examples of web browsers include Microsoft Internet Explorer (available from Microsoft Corporation, headquartered in Redmond, Wash., U.S.A.), Google Chrome which is a freeware web browser (developed by Google, headquartered in Googleplex, Mountain View, Calif., U.S.A.), Opera™ (developed by Opera Software ASA, headquartered in Oslo, Norway), and Mozilla Firefox® (developed by Mozilla Corporation headquartered in Mountain View, Calif., U.S.A.). The web-browser may be a mobile browser, such as Safari (developed by Apple Inc. headquartered in Apple Campus, Cupertino, Calif., U.S.A), Opera Mini™ (developed by Opera Software ASA, headquartered in Oslo, Norway), and Android web browser.

The steps described herein may be sequential and be performed in the described order. For example, in a case where a step is performed in response to another step, or upon completion of another step, the steps are executed one after the other. However, in case where two or more steps are not explicitly described as being sequentially executed, these steps may be executed in any order or may be simultaneously performed. Two or more steps may be executed by two different network elements, or in the same network element, and may be executed in parallel using multiprocessing or multitasking.

A tangible machine-readable medium (such as a storage) may have a set of instructions detailing part (or all) of the methods and steps described herein stored thereon, so that when executed by one or more processors, may cause the one or more processors to perform part of, or all of, the methods and steps described herein. Any of the network elements may be a computing device that comprises a processor and a computer-readable memory (or any other tangible machine-readable medium), and the computer-readable memory may comprise computer-readable instructions such that, when read by the processor, the instructions causes the processor to perform the one or more of the methods or steps described herein.

Any device or network element herein may comprise, consists of, or include a Personal Computer (PC), a desktop computer, a mobile computer, a laptop computer, a notebook computer, a tablet computer, a server computer, a handheld computer, a handheld device, a Personal Digital Assistant (PDA) device, a cellular handset, a handheld PDA device, an on-board device, an off-board device, a hybrid device, a vehicular device, a non-vehicular device, a mobile or portable device, a non-mobile or a non-portable device. Further, any device or network element herein may comprise, consist of, or include a major appliance (white goods) and may be an air conditioner, dishwasher, clothes dryer, drying cabinet, freezer, refrigerator, kitchen stove, water heater, washing machine, trash compactor, microwave oven and induction cooker. The appliance may similarly be a ‘small’ appliance such as TV set, CD or DVD player, camcorder, still camera, clock, alarm clock, video game console, HiFi or home cinema, telephone or answering machine.

The arrangements and methods described herein may be implemented using hardware, software or a combination of both. The term “software integration” or any other reference to the integration of two programs or processes herein, is used herein to include, but not limited to, software components (e.g., programs, modules, functions, processes, etc.) that are (directly or via another component) combined, working or functioning together or form a whole, commonly for sharing a common purpose or set of objectives. Such software integration can take the form of sharing the same program code, exchanging data, being managed by the same manager program, executed by the same processor, stored on the same medium, sharing the same GUI or other user interface, sharing peripheral hardware (such as a monitor, printer, keyboard and memory), sharing data or a database, or being part of a single package. The term “hardware integration” or integration of hardware components is used herein to include, but not limited to, hardware components that are (directly or via another component) combined, working or functioning together or form a whole, commonly for sharing a common purpose or set of objectives. Such hardware integration can take the form of sharing the same power source (or power supply) or sharing other resources, exchanging data or control (e.g., by communicating), being managed by the same manager, physically connected or attached, sharing peripheral hardware connection (such as a monitor, printer, keyboard and memory), being part of a single package or mounted in a single enclosure (or any other physical collocating), sharing a communication port, or used or controlled with the same software or hardware. The term “integration” herein is used herein to include as applicable, but not limited to, a software integration, a hardware integration, or any combination thereof.

Any networking protocol may be utilized for exchanging information between the network elements (e.g., clients, and servers) within the network (such as the Internet 22). For example, it is contemplated that communications can be performed using TCP/IP. Generally, HTTP and HTTPS are utilized on top of TCP/IP as the message transport envelope. These two protocols are able to deal with firewall technology better than other message management techniques. However, partners may choose to use a message-queuing system instead of HTTP and HTTPS if greater communications reliability is needed. A non-limiting example of a message queuing system is IBM's MQ-Series or the Microsoft Message Queue (MSMQ). The system described hereinafter is suited for both HTTP/HTTPS, message-queuing systems, and other communications transport protocol technologies. Furthermore, depending on the differing business and technical requirements of the various partners within the network, the physical network may embrace and utilize multiple communication protocol technologies.

The term “port” refers to a place of access to a device, electrical circuit or network, where energy or signal may be supplied or withdrawn. The term “interface” of a networked device refers to a physical interface, a logical interface (e.g., a portion of a physical interface or sometimes referred to in the industry as a sub-interface—for example, such as, but not limited to a particular VLAN associated with a network interface), and/or a virtual interface (e.g., traffic grouped together based on some characteristic—for example, such as, but not limited to, a tunnel interface). As used herein, the term “independent” relating to two (or more) elements, processes, or functionalities, refers to a scenario where one does not affect nor preclude the other. For example, independent communication such as over a pair of independent data routes means that communication over one data route does not affect nor preclude the communication over the other data routes.

Some embodiments may be used in conjunction with various devices, network elements, and systems, for example, a Personal Computer (PC), a desktop computer, a mobile computer, a laptop computer, a notebook computer, a tablet computer, a server computer, a handheld computer, a handheld device, a Personal Digital Assistant (PDA) device, a cellular handset, a handheld PDA device, an on-board device, an off-board device, a hybrid device, a vehicular device, a non-vehicular device, a mobile or portable device, a non-mobile or non-portable device, a wireless communication station, a wireless communication device, a wireless Access Point (AP), a wired or wireless router, a wired or wireless modem, a wired or wireless network, a Local Area Network (LAN), a Wireless LAN (WLAN), a Metropolitan Area Network (MAN), a Wireless MAN (WMAN), a Wide Area Network (WAN), a Wireless WAN (WWAN), a Personal Area Network (PAN), a Wireless PAN (WPAN), devices and/or networks operating substantially in accordance with existing IEEE 802.11, 802.11a, 802.11b, 802.11g, 802.11k, 802.11n, 802.11r, 802.16, 802.16d, 802.16e, 802.20, 802.21 standards and/or future versions and/or derivatives of the above standards, units and/or devices which are part of the above networks, one way and/or two-way radio communication systems, cellular radio-telephone communication systems, a cellular telephone, a wireless telephone, a Personal Communication Systems (PCS) device, a PDA device which incorporates a wireless communication device, a mobile or portable Global Positioning System (GPS) device, a device which incorporates a GPS receiver or transceiver or chip, a device which incorporates an RFID element or chip, a Multiple Input Multiple Output (MIMO) transceiver or device, a Single Input Multiple Output (SIMO) transceiver or device, a Multiple Input Single Output (MISO) transceiver or device, a device having one or more internal antennas and/or external antennas, Digital Video Broadcast (DVB) devices or systems, multi-standard radio devices or systems, a wired or wireless handheld device (e.g., BlackBerry, Palm Treo), a Wireless Application Protocol (WAP) device, or the like.

As used herein, the terms “program”, “programmable”, and “computer program” are meant to include any sequence or human or machine cognizable steps, which perform a function. Such programs are not inherently related to any particular computer or other apparatus, and may be rendered in virtually any programming language or environment including, for example, C/C++, Fortran, COBOL, PASCAL, assembly language, markup languages (e.g., HTML, SGML, XML, VoXML), and the likes, as well as object-oriented environments such as the Common Object Request Broker Architecture (CORBA), Java™ (including J2ME, Java Beans, etc.) and the likes, as well as in firmware or other implementations. Generally, program modules include routines, programs, objects, components, data structures, etc., that performs particular tasks or implement particular abstract data types. The term “application program” (also referred to as ‘application’, ‘software application’, or ‘application software’) is used herein to include, but not limited to, a computer program designed to perform a specific function directly for a user, or for another application program. Application software is typically a set of one or more programs designed to carry out operations for a specific application. Commonly, an application software is dependent on system software that manages and integrates computer capabilities, but does not directly perform tasks that benefit the user, such as an operating system, to execute. Examples of types of application software may include accounting software, media players, and office suites. Applications may be bundled with the computer and its system software, or may be published separately, and further may be developed and coded as a proprietary, or as an open-source, software. Most applications are designed to help people perform an activity.

The terms “task” and “process” are used generically herein to describe any type of running programs, including, but not limited to a computer process, task, thread, executing application, operating system, user process, device driver, native code, machine or other language, etc., and can be interactive and/or non-interactive, executing locally and/or remotely, executing in foreground and/or background, executing in the user and/or operating system address spaces, a routine of a library and/or standalone application, and is not limited to any particular memory partitioning technique. The steps, connections, and processing of signals and information illustrated in the figures, including, but not limited to any block and flow diagrams and message sequence charts, may typically be performed in the same or in a different serial or parallel ordering and/or by different components and/or processes, threads, etc., and/or over different connections and be combined with other functions in other embodiments, unless this disables the embodiment or a sequence is explicitly or implicitly required (e.g., for a sequence of reading the value, processing the value—the value must be obtained prior to processing it, although some of the associated processing may be performed prior to, concurrently with, and/or after the read operation). Where certain process steps are described in a particular order or where alphabetic and/or alphanumeric labels are used to identify certain steps, the embodiments are not limited to any particular order of carrying out such steps. In particular, the labels are used merely for convenient identification of steps, and are not intended to imply, specify or require a particular order for carrying out such steps. Furthermore, other embodiments may use more or less steps than those discussed herein. They may also be practiced in distributed computing environments where tasks are performed by remote processing devices that are linked through a communications network. In a distributed computing environment, program modules may be located in both local and remote memory storage devices.

The corresponding structures, materials, acts, and equivalents of all means plus function elements in the claims below are intended to include any structure, or material, for performing the function in combination with other claimed elements as specifically claimed. The description of the present invention has been presented for purposes of illustration and description, but is not intended to be exhaustive or limited to the invention in the form disclosed. The present invention should not be considered limited to the particular embodiments described above, but rather should be understood to cover all aspects of the invention as fairly set out in the attached claims. Various modifications, equivalent processes, as well as numerous structures to which the present invention may be applicable, will be readily apparent to those skilled in the art to which the present invention is directed upon review of the present disclosure.

All publications, standards, patents, and patent applications cited in this specification are incorporated herein by reference as if each individual publication, patent, or patent application were specifically and individually indicated to be incorporated by reference and set forth in its entirety herein.

1. A non-transitory tangible computer-readable storage medium storing a database comprising a plurality of records associated with a first group of individuals, each record is uniquely identified by a respective record identifier and is associated with a single individual from the group, wherein the respective individual information in at least one record consisting of:
at least one biometric template associated with the individual associated with the record; and
a set of traits of the individual associated with the record;
wherein the set of traits identifies a second group of multiple individuals.

2. The non-transitory tangible computer-readable storage medium according to claim 1, wherein at least one record consisting of two more biometric template associated with the individual associated with the record.

3. The non-transitory tangible computer-readable storage medium according to claim 1, wherein the respective individual information in each of all the records in the database consisting of:
at least one biometric template associated with the individual associated with the record; and
a set of traits of the individual associated with the record;
wherein the set of traits identifies multiple individuals that are part of a second group of multiple individuals.

4. The non-transitory tangible computer-readable storage medium according to claim 3, wherein the second group consists of, comprises, or is included in, the first group of individuals.

5. The non-transitory tangible computer-readable storage medium according to claim 4, wherein the second group consists of multiple individuals residing in a location, wherein the location is a street, a ZIP code, a city, a state, or a country.

6. The non-transitory tangible computer-readable storage medium according to claim 5, wherein the number of individuals in the second group is at least 5, 10, 50, 100, 500, or 1000.

7. The non-transitory tangible computer-readable storage medium according to claim 1, wherein the biometric template is a distinct and measurable human characteristics, and the biometric template consists of, includes, or is based on, an input captured from the respective record individual by a biometric sensor.

8. The non-transitory tangible computer-readable storage medium according to claim 7, wherein the human characteristics are physiological characteristics.

9. The non-transitory tangible computer-readable storage medium according to claim 7, wherein the biometric sensor is a fingerprints reader or scanner, and the captured input is a fingerprint pattern or image.

10. The non-transitory tangible computer-readable storage medium according to claim 7, wherein the fingerprints reader or scanner is optical imaging based using a visible or an invisible light, is ultrasonic imaging based, or is capacitance imaging based.

11. The non-transitory tangible computer-readable storage medium according to claim 7, wherein the biometric sensor is a hand geometry reader, and the captured input is a hand geometry pattern or image.

12. The non-transitory tangible computer-readable storage medium according to claim 7, wherein the biometric sensor is an eye iris camera, and the captured input is an eye iris pattern or image.

13. The non-transitory tangible computer-readable storage medium according to claim 7, wherein the biometric sensor is a vascular scanner, and the captured input is a vein pattern or image.

14. The non-transitory tangible computer-readable storage medium according to claim 7, wherein the biometric sensor is a digital camera, and the captured input is a face pattern or image.

15. The non-transitory tangible computer-readable storage medium according to claim 7, wherein the human characteristics are behavioral characteristics.

16. The non-transitory tangible computer-readable storage medium according to claim 15, wherein the biometric template is based on Personal Identification Number (PIN), signature or handwritten recognition, keystroke recognition, or voice/speech recognition.

17. The non-transitory tangible computer-readable storage medium according to claim 1, wherein the set of traits include a trait that is selected from a group.

18. The non-transitory tangible computer-readable storage medium according to claim 17, wherein the trait is a born trait that is the respective individual gender, race, ethnicity, skin color, hair color, or eye color.

19. The non-transitory tangible computer-readable storage medium according to claim 17, wherein the trait is a continuous variable trait that is according to, or based on, the respective individual age, weight, or height.

20. The non-transitory tangible computer-readable storage medium according to claim 1, wherein the database is a relational database system that is Structured Query Language (SQL) based.

21. A method for creating and storing a record associated with an individual in the database according to claim 1 that is part of, or connected to, a server device, the server device is communicating over the Internet with a client device that includes, or connects to, a biometric sensor and a text input interface, the method comprising the steps of:
(a) capturing, by the biometric sensor, a biometric data of the individual;
(b) capturing, by the text input interface, a set of traits of the individual;
(c) sending, by the client device, the captured biometric data or a representation thereof, and the set of traits, to the server device over the Internet;
(d) creating, by the server, a record including the captured biometric data or a representation thereof, and the set of traits, received from the client device; and
(e) storing in the database the created record, wherein the set of traits identifies a second group of multiple individuals.
wherein the set of traits identifies a group of multiple individuals.

22. The method according to claim 21 wherein the client device is sending the captured biometric data to the server device.

23. The method according to claim 21 wherein the client device is sending a biometric template that is unique to the captured biometric data to the server device.

24. The method according to claim 21 wherein the text input interface is a keyboard or a pointing device.

25. The method according to claim 21 wherein the client device includes, or connects to, multiple biometric sensors, and wherein the captured biometric data includes biometric data captured from the multiple biometric sensors.

26. A method for controlling access of an individual to a resource based on the database according to claim 1 that is part of, or connected to, a server device, the database storing a record associated with the individual and including a first biometric data or representation thereof and a set of traits, the server device is communicating over the Internet with a client device that includes, or connects to, a biometric sensor and a text input interface, the method comprising the steps of:
(a) capturing, by the biometric sensor, a second biometric data of the individual;
(b) sending, by the client device, the second captured biometric data or a representation thereof, to the server device over the Internet;
(d) fetching, by the server device, the record associated with the individual;
(e) comparing, by the server device, the first biometric data or the representation thereof to the received second captured biometric data or a representation thereof;
(f) determining, by the server device, whether the first biometric data or the representation thereof and the received second captured biometric data or a representation thereof are of the same person; and
(g) in response to determining that the first and second biometric data or the representation thereof are not of the same person, sending, by the server device, a message to the client device over the Internet.

27. The method according to claim 26 wherein in response to determining that the first and second biometric data or the representation thereof are of the same person, sending part of, or whole of, the set of traits to the client device.

28. The method according to claim 26 wherein the client device is sending a biometric template that is unique to the second captured biometric data to the server device.

29. The method according to claim 26 wherein the client device includes, or connects to, multiple biometric sensors, and wherein the captured second biometric data includes biometric data captured from the multiple biometric sensors.
